(19) United States
(12) Patent Application Publication
(10) Pub. No.: US 2024/0182157 A1
(43) Pub. Date: Jun. 6, 2024

(54) Advanced Generalized Predictive Control

(71) Applicant: UNITED STATES OF AMERICA AS REPRESENTED BY THE ADMINISTRATOR OF NASA, Washington, DC (US)

(72) Inventor: Thomas G. Ivanco, Yorktown, VA (US)

(21) Appl. No.: 18/526,067

(22) Filed: Dec. 1, 2023

Related U.S. Application Data
(60) Provisional application No. 63/429,326, filed on Dec. 1, 2022.

(51) Int. Cl. B64C 13/16

(52) U.S. Cl. CPC B64C 13/16

(57) ABSTRACT

A method of controlling a vehicle utilizing a controller having a vehicle model that corresponds to the vehicle. The method includes utilizing the controller to provide inputs during vehicle operation, and measuring vehicle outputs for a plurality of times while the vehicle is in operation. The method further includes determining modeling parameters of the vehicle model to thereby model vehicle behavior, wherein the modeling parameters are determined based upon the utilized inputs and the measured outputs. Predicted vehicle outputs for the plurality of times are determined, at least in part, by utilizing the determined modeling parameters. The system further includes determining a system error for the plurality of times utilizing a difference between the measured vehicle outputs and the predicted vehicle outputs. The vehicle model is modified to provide adaptive changes while the vehicle is in operation based, at least in part, on the system error.

### CROSS-REFERENCE TO RELATED PATENT APPLICATION(S)

This patent application claims the benefit of and priority to U.S. Provisional Patent Application No. 63/429,326, filed on Dec. 1, 2022 entitled “ADVANCED GENERALIZED PREDICTIVE CONTROL,” the contents of which is hereby incorporated by reference in its entirety.

### STATEMENT REGARDING FEDERALLY SPONSORED RESEARCH OR DEVELOPMENT

The invention described herein was made by an employee of the United States Government and may be manufactured and used by or for the Government of the United States of America for governmental purposes without the payment of any royalties thereon or therefore.

### BACKGROUND OF THE INVENTION

Generalized Predictive Control (GPC) is an advanced form of an adaptive control algorithm that uses experimentally acquired data to determine the input-output relationship of complex systems through a process called system identification (system ID). GPC has been applied to wind tunnel tests of dynamically-scaled tiltrotor aircraft for stability augmentation and vibration reduction since the complex nature of these dynamic systems may not lend itself well to traditional control theory. GPC is also applicable to many dynamic systems and can be ideal for complex systems that are difficult to explicitly model analytically.

### BRIEF SUMMARY OF THE INVENTION

An aspect of the present disclosure is a control system and method referred to herein as Advanced GPC (AGPC) which improves upon traditional GPC by enabling self-adaptation as conditions change from those used to acquire the system ID and controller performance would normally erode. To support AGPC, the present disclosure also identifies and describes figures of merit that define a working controller and quantifies the uniqueness of the control inputs and quality of the system ID parameters. AGPC according to the present disclosure may perform better than traditional GPC and can successfully adapt to changing conditions.

An aspect of the present disclosure is a method of controlling a vehicle utilizing a controller having a vehicle model that corresponds to the vehicle. The method includes utilizing the controller to provide inputs during vehicle operation, and measuring vehicle outputs for a plurality of times while the vehicle is in operation. The method further includes determining modeling parameters of the vehicle model to thereby model vehicle behavior, wherein the modeling parameters are determined based upon the utilized inputs and the measured outputs. Predicted vehicle outputs for the plurality of times are determined, at least in part, by utilizing the determined modeling parameters. The system further includes determining a system error for the plurality of times utilizing a difference between the measured vehicle outputs and the predicted vehicle outputs. The vehicle model is modified to provide adaptive changes while the vehicle is in operation based, at least in part, on the system error.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

FIG. 1 is a perspective view of a tiltrotor vehicle according to an aspect of the present disclosure;

FIG. 2 is a perspective view of the TiltRotor Aeroelastic Stability Testbed (TRAST) in a Transonic Dynamic Tunnel;

FIG. 3 comprises a graph showing actual and predicted system response from a 5DOF simulation to develop figures of merit;

FIG. 4 comprises a graph showing portion of time history of actual and predicted system response from a 5DOF simulation;

FIG. 5 comprises a graph showing normalized residuals for time history of a 5DOF simulation;

FIG. 6A is a partially fragmentary isometric view of a simple tiltrotor model for a small wind tunnel;

FIG. 6B is a partially fragmentary isometric view of a simple tiltrotor model for a small wind tunnel;

FIG. 7 is a partially fragmentary isometric view of a small wind tunnel used for the tiltrotor model of FIG. 6;

FIG. 8A is a partially fragmentary perspective view of the TRAST model details with shakers connected;

FIG. 8B is a partially fragmentary perspective view of the TRAST model details with shakers connected;

FIG. 9A is a graph showing open-loop commands to the tiltrotor model of FIG. 6;

FIG. 9B is a graph showing open-loop response of the tiltrotor model of FIG. 6 to the commands of FIG. 9A wherein, V=19.06 ft/s;

FIG. 10A comprises a graph showing a system ID (commands) of the simple tiltrotor model of FIG. 6 wherein, V=19.06 ft/s;

FIG. 10B comprises a graph showing a system ID (response) of the simple tiltrotor model of FIG. 6 wherein, V=19.06 ft/s for the inputs of FIG. 10A;

FIG. 11A a graph showing closed-loop commands of the simple tiltrotor model of FIG. 6 utilizing traditional GPC, wherein V=19.06/ft/s;

FIG. 11B is a graph showing closed-loop response of the simple tiltrotor model of FIG. 6 utilizing traditional GPC, wherein V=19.06 ft/s to the inputs of FIG. 11A;

FIG. 12A is a graph showing closed-loop commands to the simple tiltrotor model of FIG. 6 wherein the system ID was acquired at 19.06 ft/s utilizing traditional GPC, wherein V=21.17 ft/s;

FIG. 12B is a graph showing closed-loop response of the simple tiltrotor model of FIG. 6 wherein the system ID was acquired at 19.06 ft/s utilizing traditional GPC, wherein V=21.17 ft/s;

FIG. 13 comprises a graph showing open-loop response of the simple tiltrotor model of FIG. 6 wherein, V=21.17 ft/s;

FIG. 14A is a graph showing commands of a new system ID acquired at V=21.17 ft/s while closed-loop while closed-loop with previous system ID acquired at 19.06 ft/s;

FIG. 14B is a graph showing a response of the new system ID to the commands of FIG. 14A acquired at V=21.17 ft/s while closed-loop while closed-loop with previous system ID acquired at 19.06 ft/s;

FIG. 15A is a graph showing closed-loop commands to the simple tiltrotor model of FIG. 6 with updated system ID, wherein V=21.17 ft/s, utilizing traditional GPC with the new system ID of FIG. 14;

FIG. 15B comprises a graph showing closed-loop response of the simple tiltrotor model of FIG. 6 to the commands of FIG. 15A;

FIG. 16A is a graph showing closed-loop commands to the simple tiltrotor model of FIG. 6 with dither applied, utilizing traditional GPC and AGPC self-correcting algorithm, wherein V=21.17 ft/s;

FIG. 16B is a graph showing closed-loop response of the simple tiltrotor model of FIG. 6 to the commands of FIG. 16A;

FIG. 17A is a graph showing open-loop inputs to TRAST, inertial shaker sweep, helicopter mode (90 deg.), no blades;

FIG. 17B is a graph showing open-loop response of TRAST to the commands of FIG. 17A;

FIG. 18A is a graph showing system ID (inputs) to the TRAST in helicopter mode, no blades;

FIG. 18B is a graph showing system ID (response) of TRAST to the inputs of FIG. 18A;

FIG. 19A is a graph showing inputs to TRAST in helicopter mode, utilizing traditional GPC with inertial shaker;

FIG. 19B is a graph showing open-loop then closed-loop response of TRAST to the inputs of FIG. 19A;

FIG. 20 is a partially fragmentary perspective view of the TRAST model with sandbags installed to alter the natural frequency of the wing;

FIG. 21A is a graph showing open-loop input to TRAST, inertial shaker sweep with tighter bandwidth, three sandbags;

FIG. 21B is a graph showing open-loop response of TRAST to the commands of FIG. 21A;

FIG. 22A is a graph showing closed-loop input to TRAST, inertial shaker sweep with tighter bandwidth, three sandbags;

FIG. 22B is a graph showing closed-loop response of TRAST to the inputs of FIG. 22A;

FIG. 23 is a partially fragmentary perspective view of the TRAST model with nacelle at 60 degrees, with arbitrary masses mounted to swashplate;

FIG. 24A is a graph showing TRAST open-loop inputs, nacelle at 60 degrees, inertial shaker;

FIG. 24B is a graph showing TRAST open-loop response to the inputs of FIG. 24A;

FIG. 25A is a graph showing TRAST closed-loop inputs, nacelle at 60 degrees, inertial shaker;

FIG. 25B is a graph showing TRAST closed-loop response to the inputs of FIG. 25A;

FIG. 26A is a graph showing TRAST open then closed-loop inputs, nacelle at 60 degrees, external shaker to mimic instability, traditional GPC;

FIG. 26B is a graph showing TRAST open-then closed-loop response to the inputs of FIG. 26A;

FIG. 27A is a graph showing TRAST open-looped inputs, helicopter mode with blades on at 300 rpm, resonant response;

FIG. 27B is a graph showing TRAST open-loop response to the inputs of FIG. 27A;

FIG. 28A is a graph showing TRAST closed-loop inputs, helicopter mode blades on at 300 rpm, system ID acquired at 500 rpm;

FIG. 28B is a graph showing TRAST closed-loop response to the inputs of FIG. 28A;

FIG. 29A is a graph showing TRAST closed-loop inputs, helicopter mode blades on at 300 rpm, system ID acquired at 270 rpm;

FIG. 29B is a graph showing TRAST closed-loop response to the inputs of FIG. 29A;

FIG. 30A is a graph showing a control inputs with inertial shaker for traditional GPC;

FIG. 30B is a graph showing response to the inputs of FIG. 30A for traditional GPC;

FIG. 30C is a graph showing inputs for with inertial shaker for traditional GPC;

FIG. 30D is a graph showing response to the inputs of FIG. 30C for AGCP.

FIG. 31A is a graph showing TRAST opened then closed-loop inputs (traditional GPC), nacelle at 60 degree transition, external shaker to mimic instability;

FIG. 31B is a graph showing TRAST opened then closed-loop response (traditional GPC) to the inputs of FIG. 31A;

FIG. 31C is a graph showing TRAST opened then closed-loop inputs (traditional AGPC), nacelle at 60 degree transition, external shaker to mimic instability;

FIG. 31D is a graph showing TRAST opened then closed-loop response (traditional AGPC) to the inputs of FIG. 31A;

FIG. 32A is a graph showing TRAST closed-loop inputs (traditional GPC), helicopter mode with blades on at 300 rpm;

FIG. 32B is a graph showing TRAST closed-loop response to the inputs of FIG. 32A (traditional GPC);

FIG. 32C is a graph showing TRAST closed-loop inputs (traditional AGPC), helicopter mode with blades on at 300 rpm;

FIG. 32D is a graph showing TRAST closed-loop response to the inputs of FIG. 32C (traditional AGPC);

FIG. 33A is a graph showing TRAST closed-loop inputs (traditional GPC), helicopter mode with blades on at 300 rpm, 270 rpm system ID;

FIG. 33B is a graph showing TRAST closed-loop response (traditional GPC) to the inputs of FIG. 33A, showing bending response only;

FIG. 33C is a graph showing TRAST closed-loop inputs (traditional AGPC), helicopter mode with blades on at 300 rpm, 270 rpm system ID;

FIG. 33D is a graph showing TRAST closed-loop response (traditional AGPC) response to the inputs of FIG. 33C, showing bending response only;

FIG. 34A is a graph showing TRAST closed-loop inputs (traditional GPC), helicopter mode with blades on at 680 rpm, 727 rpm system ID;

FIG. 34B is a graph showing TRAST closed-loop response (traditional GPC) to the inputs of FIG. 34A;

FIG. 34C is a graph showing TRAST closed-loop inputs (traditional AGPC), helicopter mode with blades on at 680 rpm, 727 rpm system ID;

FIG. 34D is a graph showing TRAST closed-loop response (traditional AGPC) to the inputs of FIG. 34C;

FIG. 35A is a graph showing TRAST closed-loop inputs (traditional GPC), helicopter mode with blades on at 680 rpm, 727 rpm system ID;

FIG. 35B is a graph showing TRAST closed-loop response (traditional GPC) showing wing bending and nacelle pitch response only, no actuator B;

FIG. 35C is a graph showing TRAST closed-loop inputs (traditional AGPC), helicopter mode with blades on at 680 rpm, 727 rpm system ID;

FIG. 35D is a graph showing TRAST closed-loop response (traditional AGPC) showing wing bending and nacelle pitch response only, no actuator B;

FIG. 36 is a schematic of an AGCP system according to an aspect of the present disclosure; and

FIG. 37 is a flowchart showing operation of an AGPC system according to an aspect of the present disclosure.

### DETAILED DESCRIPTION OF THE INVENTION

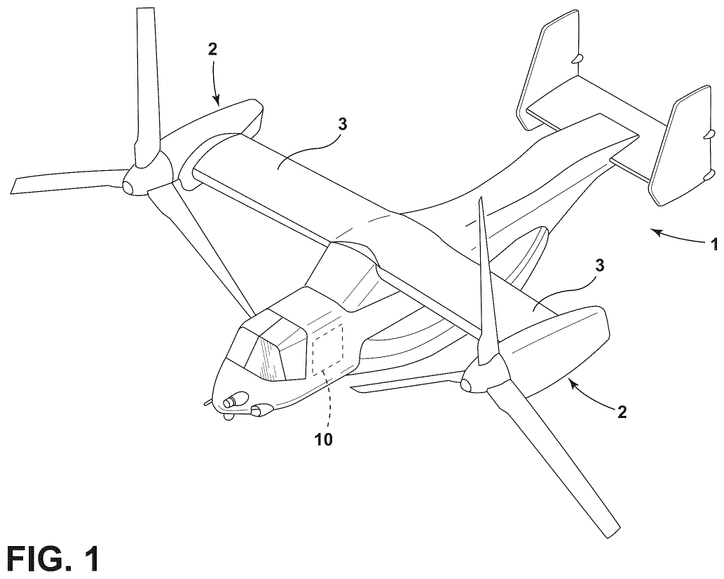

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

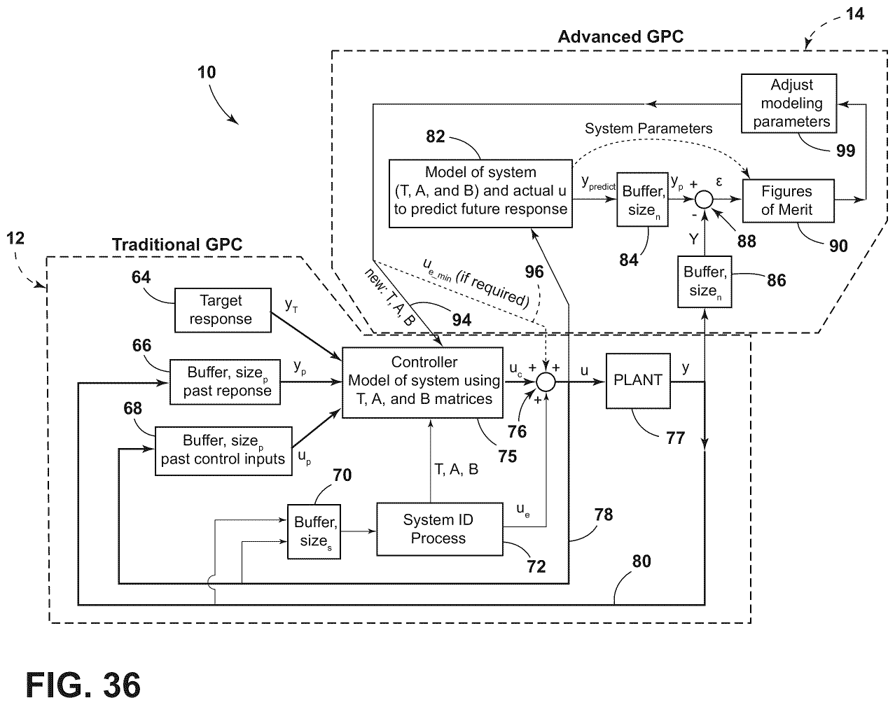

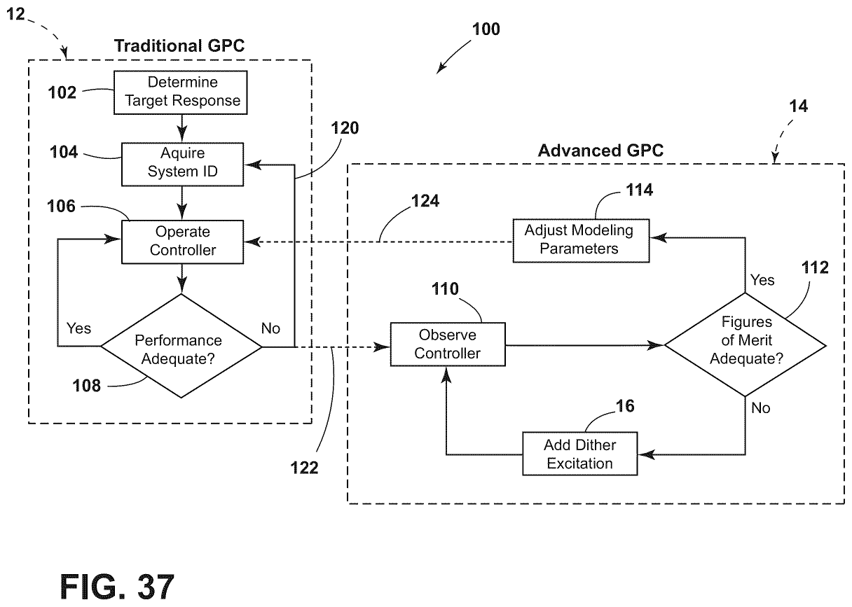

Vehicles or systems such as tiltrotor aircraft 1 (FIG. 1) may have the potential to expand rotary-wing operational boundaries. However, they may be limited in forward flight speed due to complex coupled rotor and wing dynamic instabilities known as proprotor pylon instability, often referred to as whirl flutter. The present disclosure includes a control system 10 that may be utilized in an aircraft 1 or virtually any other system. As discussed in more detail below in connection with FIGS. 36 and 37, control system 10 may comprise traditional GPC 12 and advanced GPC (AGPC) 14.

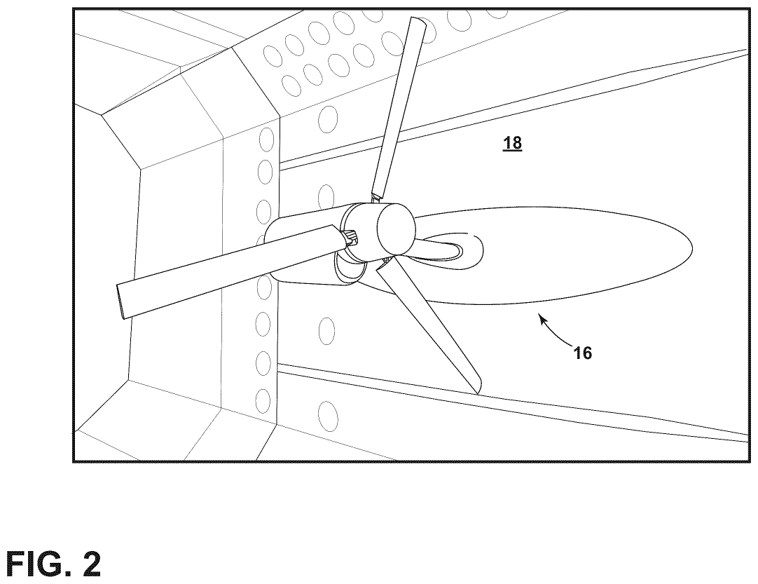

With reference to FIG. 2, a TiltRotor Aeroelastic Stability Testbed (TRAST) 16 has been developed to test proprotors in the NASA Langley Research Center Transonic Dynamics Tunnel (TDT) 18 to investigate these aeroelastic instabilities. The TRAST model is detailed in Kreshock, A. R., Thornburgh, R. P., and Wilbur, M. L., “Overview of the TiltRotor Aeroelastic Stability Testbed,” presented at the AIAA SciTech Forum, San Diego, CA, January 2022, AIAA 2022-0566. Doi 10.2514/6.2022-0566 and the TDT test capabilities are described in Ivanco, T. G., “Unique Testing Capabilities of the NASA Langley Transonic Dynamics Tunnel, an Exercise in Aeroelastic Scaling,” presented at the AIAA SciTech Forum, San Diego, CA, June 2013. AIAA 2013-2625. doi: 10.2514/6.2013-2625.

An aspect of the present disclosure is the use of active controls to stabilize the aircraft 1 beyond the (nominal) stability boundary and to reduce vibration. Advanced GPC (AGPC) according to the present disclosure permits (causes) the controller 10 to self-adjust as flight or vehicle conditions change.

Another aspect of the present disclosure involves figures of merit that quantify controller performance and reliability. It will be understood that AGPC according to the present disclosure is applicable to a wide variety of dynamic systems including, for example, fixed wing aircraft, motor vehicles, etc.

The governing equation for known GPC is presented herein as Equation 1. In this equation, y is the response output, u is the control input, k is the discrete time step index, the prediction horizon (hₚ) is the limit of future state estimates, and the control horizon (h_{c}) is the limit of the finite control horizon after which the controls are assumed to be zero. Past input and output values are denoted as uₚ and yₚ respectively and contain p values of u and y. The matrices T, A, and B represent the Observer Markov Parameters (OMP). In known GPC, an experimental system identification (system ID) process may be used to determine the OMP matrices. In the present disclosure, “system ID” generally refers to a successfully computed set of OMP matrices with associated weight values rather than the process of identifying those matrices.

yₕ_{ₚ}(k)=Tuₕ_{_{c}}(k)+Ayₚ(k−p)+Buₚ(k−p) (1)

where, the subscripts hₚ, h_{c}, and p denote the size of the respective vectors, and the parenthetical values represent the starting index.

The objective function of known GPC is shown herein as Equation 2. In known GPC, controls u may be determined from minimalization of this function.

J=ε^{T}Rε+uₕ_{_{c}}^{T}Quₕ_{_{c}} (2)

where, ε is the error between the target response (y_{T}) and the predicted response ε=y_{T}−yₕ_{ₚ}, R is the weighting matrix for error, and Q is the weighting matrix for control input.

In the case of a regulator where the target response is zero, the error term ε becomes the response y.

Traditional (known) GPC may be somewhat effective, and it has been used in many dynamic systems. However, the performance of traditional GPC may erode as conditions change from those used to derive the system ID. For example, in aircraft systems, these changes may comprise one or more of a change in flight condition, payload, fuel load, airspeed, or other flight characteristics. Therefore, a potential drawback of GPC is that it may need to be continually updated with new system ID acquisitions as conditions change. These new system ID acquisitions introduce disturbances that are contrary to the purpose of a vibration reduction controller. Additionally, some scenarios such as flight beyond a flutter boundary may not allow the acquisition of a new system ID due to the dynamic response of the aircraft and resulting signal to noise ratio.

In contrast to known GPC, AGCP according to an aspect of the present disclosure provides self-adjustment of a working controller. AGPC may utilize a system error term (ξ) that can be numerically determined from measured data using Equation 3 after the system described by Equation 1 progresses at least hₚ timesteps beyond k. Thus, a working controller can be improved or updated by changes to the OMP matrices done by observation of the input-output relationships during controller operation.

$$ξ = {y}_{{h}_{{p}_{actual}}} - {y}_{{h}_{{p}_{predicted}}} + \{ φ \} = {y}_{{h}_{{p}_{actual}}} - [ {Tu}_{{h}_{{c}_{actual}}} ( k ) + {Ay}_{p} ( k - p ) + {Bu}_{p} ( k - p ) ] + \{ φ \} \qquad ( 3 )$$

where φ represents noise and external disturbances.

The subscript actual in Equation 3 indicates the actual measurements of response and control inputs after an additional hₚ timesteps occur beyond k. If it is assumed that the noise and disturbances represented by φ follow a random pattern, then repeated computations should cancel these disturbances. If we continue to an additional s timesteps, then one would have s-hₚ computations of ξ to minimize the effect of φ. If φ is minimized and all the values of y and u shown in Equation 3 are now measured, then the only uncertainty that should remain is the error (or “delta” values) in the observer matrices T, A, and B. After these s timesteps, Equation 3 can be expanded into the matrix form shown in Equation 4 where the delta operator indicates the error in the observer T, A, and B matrices where the control and state matrices are of width s-hₚ. The delta matrix values can then be determined by Equation 5 and the updated values of T, A, and B by Equation 6.

$$[ ζ ] = [ Δ T \vert Δ A \vert ΔB ] \{ \begin{matrix}[ {u}_{{h}_{{c}_{actual}}} ] \\ [ {y}_{p} ( k - p ) ] \\ [ {u}_{p} ( k - p ) ]\end{matrix} \} \qquad ( 4 )$$

$$[ Δ T \vert Δ A \vert Δ B ] = [ ξ ] pinv ( \{ \begin{matrix}[ {u}_{{h}_{{c}_{actual}}} ] \\ [ {y}_{p} ( k - p ) ] \\ [ {u}_{p} ( k - p ) ]\end{matrix} \} ) \qquad ( 5 )$$

$${T}_{n e w} = {T}_{o l d} + Δ T \qquad ( 6 )$$

$${A}_{n e w} = {A}_{o l d} + Δ A$$

$${B}_{n e w} = {B}_{o l d} + Δ B$$

As described above, AGPC according to an aspect of the present disclosure uses additional data while the controller 10 is operating to compute errors in the system model OMP matrices. With the additional data, the modelling errors can be minimized, and the controller 10 can adapt to changing conditions to build upon an existing “good” system ID.

An adaptive controller that self-corrects preferably only corrects the errors of a controller without worsening a good performing controller. With a good performing (effective) controller, there may be little system response or actuator workload, and adaptive metrics may be clouded by signal noise, causing very poor adaptive corrections. Thus, another aspect of the present disclosure comprises figures of merit that may be utilized to quantify the goodness of an operating controller and the reliability of adaptive corrections.

To quantify the effectiveness of the controller, the magnitude of the objective function was utilized since the purpose of the controller is to minimize this function. In the absence of other information, a benchmark for comparison is the magnitude of this objective function during the system ID acquisition assuming that the system was stable and the signal to noise ratio was adequate but not excessive. The objective function equation, (Equation 2) produces a matrix. An effective scalar equivalent is the largest absolute value from within that matrix. Once an effective controller is implemented, it is possible to subjectively determine how large the objective function value should be based upon acceptable system behavior. The objective function is a quantitative value reflecting the magnitude of the system response and controller workload with appropriate weighting matrices R and Q applied. The maximum absolute value of the objective function acquired during a good system ID process is therefore typically a reliable figure of merit that may be utilized to determine the “goodness” of the controller since the desired weighting is already included.

In addition to the performance or effectiveness of the controller, it is also possible to quantify the likelihood of the self-adaptive routine to improve performance. Proper system ID may require that the controls be distinguishable from one another. For example, consider simultaneous actuator motion of a tiltrotor swashplate to enable a collective input that suppresses a wing out-of-plane bending vibration when in the helicopter-mode. If the control u consists of individual actuator positions, then all controls are moving in unison. Using these data and associated system ID (or system ID improvement) to determine the relationship to control other modes, such as a wing-chord mode, may not be possible. Self-adaptive correction to the matrices in this case could cause erratic behavior in the chord response. Thus, another metric of interest is the orthogonality or independence of the various controls to quantify control uniqueness.

Control orthogonality or uniqueness may be determined in at least two manners. First, the vector product of the three independent commands may be computed for the time history. Second, the pairwise correlation coefficient between the various controls (and responses) may be computed based upon the relation shown in Equation 7 to determine data collinearity.

$${ru}_{ij} = \frac{{( {u}_{i} - \overline{{u}_{ι}} )}^{T} ( {u}_{j} - \overline{{u}_{J}} )}{\sqrt{{( {u}_{i} - \overline{{u}_{ι}} )}^{T} ( {u}_{i} - \overline{{u}_{ι}} )} \sqrt{{( {u}_{j} - \overline{{u}_{J}} )}^{T} ( {u}_{j} - \overline{{u}_{J}} )}} \qquad ( 7 )$$

where the subscripts i and j denote the control number, the bar ( ) denotes the mean, and i≠j.

For purely orthogonal controls, the vector product determined by the first method should be zero. This may be a useful metric in some cases. If the vector product is orders of magnitude less than the individual signal amplitudes, then the likelihood of a reliable system ID is high. During physical experiments, this metric may be less useful, and it may be difficult to determine a meaningful limit to this value. As controls work harder, for example, the value of the product may increase yet the controls may still be unique enough to derive a reliable input-output relationship. By contrast, the second method using the correlation coefficient between control channels (Equation 7) may be normalized by control magnitude which may make it more adaptable to different systems or levels of workload. Prior papers suggest that a correlation coefficient of less than 0.9 is required to ensure that data collinearity problems do not exist. The system ID efforts described herein using either orthogonal multisines or band-limited white noise with independent seeds resulted in correlation coefficients below 0.1 indicating that the excitation command uniqueness was more than adequate. However, command signals generated from controller employment during closed-loop operation may not meet this uniqueness requirement. Therefore, the correlation coefficients may be monitored before employing AGPC to self-adapt the system ID. If the correlation coefficients are inadequate, then dither, preferably in the form of orthogonal multisines, may be added to the commands to improve the coefficients. By monitoring these coefficients, the minimal amount of required dither may be determined in order to minimize excitation of the system and maintain favorable response.

In addition to quantifying the performance of the controller and uniqueness of the inputs, two other metrics may be employed to quantify the quality of the system ID fit to the system behavior. The first is the coefficient of determination (R²) for each response and the second is the normalized residuals computed as the residuals normalized by 3σ where σ is the standard deviation of each response time history. Equations for the coefficient of determination are available from multiple sources. An example is shown herein as Equation 8.

The residual is the difference between the model-predicted response value minus the actual as shown in Equation 3.

$${R}^{2} = 1 - \frac{RSS ( {y}_{{h}_{{p}_{a c t u a l}}} - {y}_{{h}_{{p}_{p r e d i c t e d}}} )}{RSS ( {y}_{{h}_{{p}_{a c t u a l}}} )} \qquad ( 8 )$$

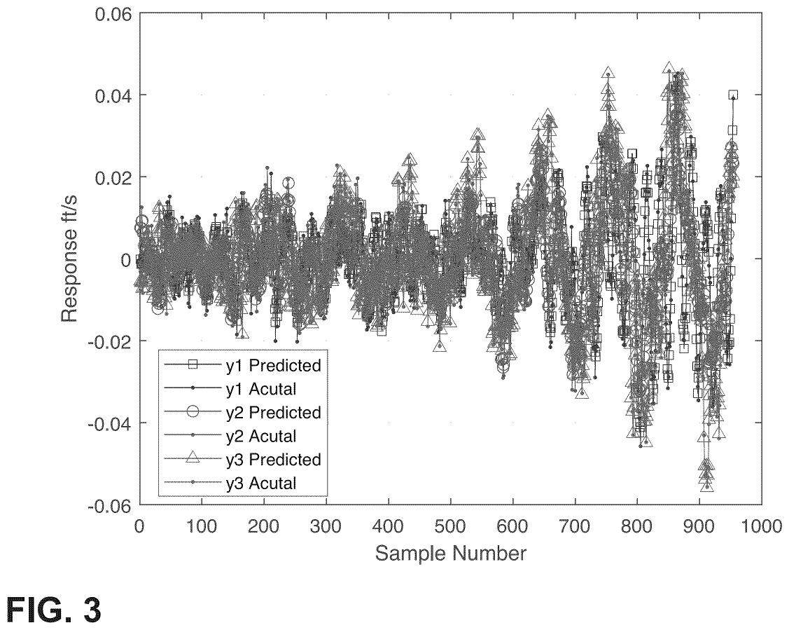

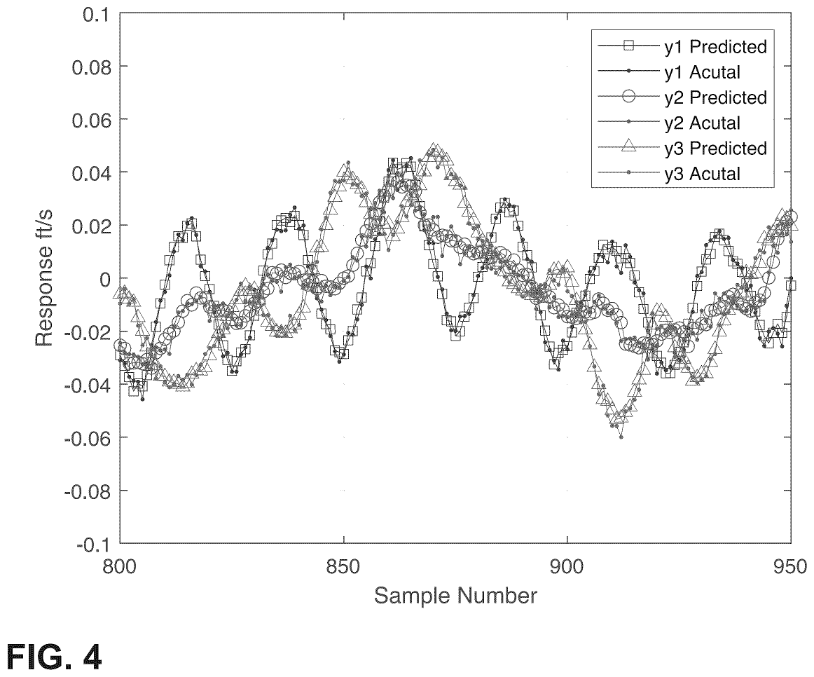

Example figures of merit values follow for a system ID acquired for an example five degree-of-freedom (5DOF) linear mass-spring-damper system with response being the velocity of masses 1, 2 and 4 and commands being force applied to masses 1, 3 and 5. FIG. 3 shows time history simulation data alongside corresponding predicted values using system ID results. A close-up of a portion of this time history is shown in FIG. 4.

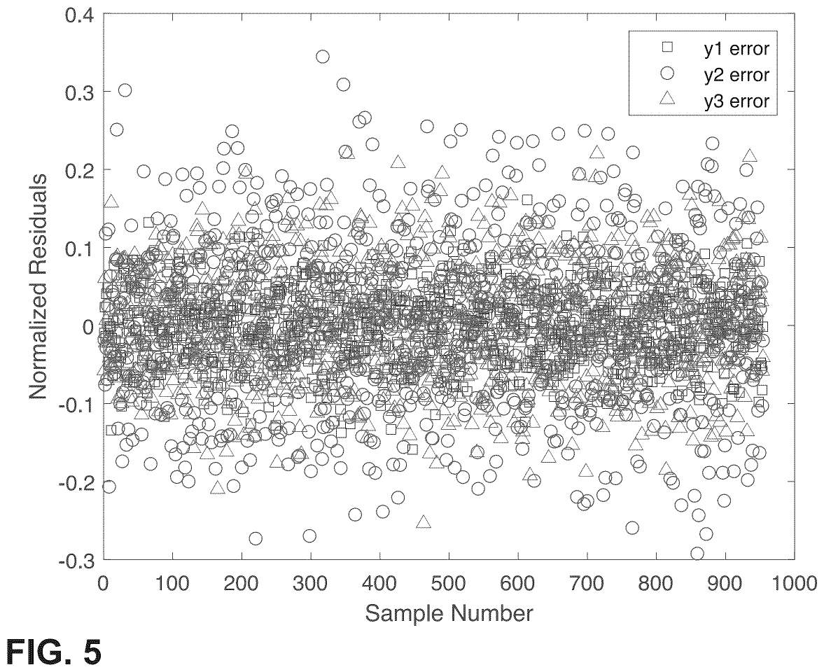

For the simulation shown in FIGS. 3 and 4, the coefficients of determination for y1, y2, and y3 are 0.9794, 0.9041, and 0.9492 respectively. These high values of coefficients indicate that the system ID produces a good approximation of the system response behavior. Additionally, the pairwise correlation coefficients between commands 1 and 2, commands 1 and 3, and commands 2 and 3 are 0.0146, 0.0295, and 0.0028 respectively and between the responses 1 and 2, responses 1 and 3, and responses 2 and 3 are 0.6368, 0.6606, and 0.2746 respectively. Therefore, the responses are distinguishable (less than 0.9), and the excitation commands have low correlation and are nearly orthogonal. Additionally, a qualitative assessment can be done by reviewing FIG. 3 and FIG. 4, where the system ID provides a good model to the system behavior. The lowest coefficient of determination corresponds to the response y2 where the signal noise magnitude appears relatively higher by comparison to the responses y1 and y3. Normalized residuals (normalized by 3 σ) for the time histories are shown in FIG. 5. As one can see, the residuals are higher for y2 and correspond to the lower coefficient of determination for that response.

It can be seen that the behavior of the residuals is favorable. They are scattered about zero indicating that the system ID results do not contain a significant static offset in system behavior. Additionally, no discernable pattern or trend is recognizable as a function of sample number (or time) indicating that there are no deterministic components remaining and that the system residuals are satisfactory.

Additional figures of merit that may be used to quantify the validity of the system ID are the rank and maximum absolute value of the objective function. The rank of the objective function matrix may lend insight into the distinguishability of the response measurements and the independence (degree of orthogonality) of the command inputs. For the system ID acquired above, the objective function produces a matrix of size 954×954 (1000 samples with order p=20, and prediction/control horizon hp=hc=25 such that 1000−20−25−1=954). For these results, the rank of the objective function was 150. Since the system ID results are favorable, this value of 150 may serve as a guide to determine if the distinguishability of the response and orthogonality of the commands during operational use of the controller at various conditions are adequate to provide reliable identification of the system with the controller active.

If the objective function rank is too low, or if the orthogonality parameter is too high, dither may be added to the controls to improve the distinguishability when self-adaptive AGPC is utilized. The value of 150 is far removed from the size of the objective function matrix, which suggests that many rows or columns are linear combinations of other rows or columns. Since the ARX model is an autoregressive model that builds upon previous samples to develop a regressive time history, each time step builds a new row shifted in index from the other rows. With the example sample size, order of the model, and horizon values shown, a rank of 150 may be about the highest value that would be expected with these parameters. As model order, sample size, control horizon, or prediction horizon changes, then an acceptable rank value will also change. Thus, an understanding of the model may be helpful with regards to determining acceptable figures of merit.

The real-time controller used for the experimental testing described herein is the dSPACE® MicroLabBox 1202. MATLAB Simulink® GPC software was run in dSPACE after conversion to an executable using the “X in the loop” (XIL) standard application protocol interface (API). A signal definition file was also generated as part of the MATLAB® conversion and was used to link the dSPACE controller to the software interface called “Control Desk.” An additional hurdle associated with running GPC is the need to run complex matrix computations that are far more convenient to run in MATLAB® scripts. Therefore, MATLAB® to dSPACE model access port (MA-Port) connections were established that enable the real-time reading and writing of variables to and from MATLAB and dSPACE.

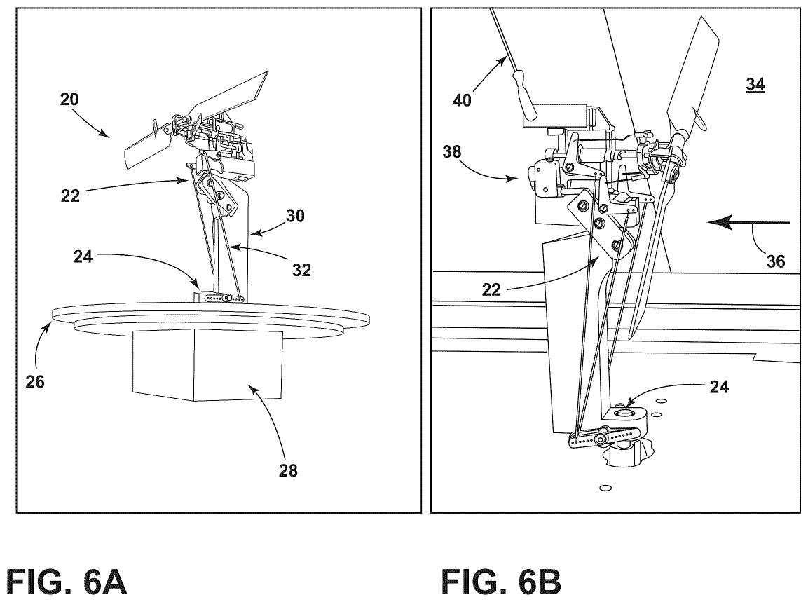

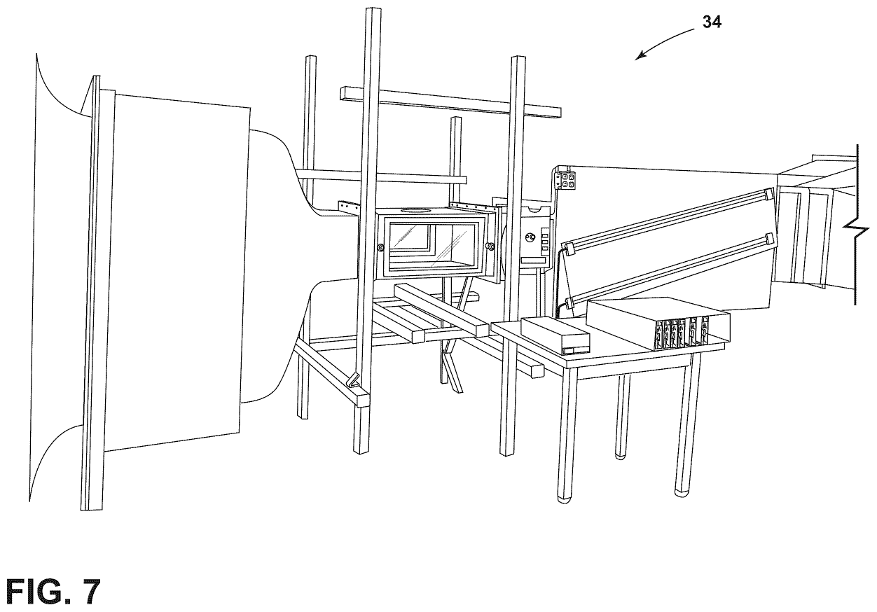

For testing purposes, a miniature (simple) tiltrotor model 20 (FIG. 6) was constructed from off-the-shelf miniature radio controlled (RC) helicopter parts and robotic servos. The simplified model 20 includes a pivot bearing/pylon yaw 22, a pivot bearing/wing pitch 24, a servo and torque transducer mount block 28, a wing 30, control tubes 32. The model may be disposed on a floor 26 of a wind tunnel 34 (see also FIG. 7). A fore-aft accelerometer 38 and an LVDT 40 may also be utilized in the wind tunnel setup (FIG. 6). A Blade mCPX BNF was chosen as the helicopter model because it was very small with an eight-inch rotor diameter allowing it to fit inside of a small wind tunnel, and it utilizes a fully articulated swashplate allowing collective and cyclic control. To obtain the required frequency response of the controls, high-performance Park GWS HPX F robotic servos were utilized. These servos are much larger than what is specified for the Blade helicopter, and they also have increased torque and speed enabling adequate frequency response up to 15 Hz. To control the servos, a Maestro “Micro 6” 6-channel circuit board was integrated with the servos to convert voltage magnitude from the real-time controller into servo specific pulse-width-modulation (PWM) commands. With this circuit board setup, the real-time controller could output its typical voltage commands as it would do for hydraulic servo actuators. Therefore, the same GPC controller hardware and software was used for the simple tiltrotor model 20 and the more complex TRAST model. The tiltrotor model 20 is shown in FIGS. 6A, 6B highlighting the design details and the small wind tunnel 34 is shown in FIG. 7.

To create the dynamic characteristics of a tiltrotor whirl flutter instability, pylon pitch and yaw degrees of freedom were allowed. These degrees of freedom were achieved with the use of C-Flex pivot bearings to provide lowly-damped hinge axes with acceptable spring rates. C-Flex pivot bearings are barrel shaped and provide linear stiffness with angle. The stiffness is achieved with cruciform beam connections on the interior of the barrel components, and angular displacement is limited by contact between internal barrel structures as the bearing rotates. This limitation in angular displacement by a hard stop of the flexure serves to limit amplitude for any dynamic instability encountered by the wind-tunnel model 20 and allows it to safely go beyond the flutter boundary.

Instrumentation included a torque transducer mounted to the wing base, accelerometers mounted to the nacelle, and a linear variable displacement transducer (LVDT) 40 measuring nacelle motion. Additional details of the simple tiltrotor model 20 and data acquisition are provided in Ivanco, T. G., Newman, B. A., Alberts, T. E., Bawab, S. Y., Baysal, O., and Silva, W. A., “Advanced Generalized Predictive Control and its Application to Tiltrotor Aircraft for Stability Augmentation and Vibration Reduction,” Ph.D. Dissertation, Old Dominion University, Norfolk, VA, 2022. doi: 10.25777/qbqq-ez94.

As noted above, the TRAST model 16 (FIG. 2) is described in detail in prior publications. Applying an active control system to a complex rotorcraft model such as TRAST 16 may require an incremental approach to reduce risk to the model and facility. Application of GPC 12 and AGPC 14 (see also FIGS. 36, 37) to the TRAST model 16 was done first on the model with no blades and no rotation of the rotor system. The only control effector in this configuration was the mass of the swashplate thereby minimizing the risk to model systems. Once the controller and safety protocols proved satisfactory, the rotor system was rotated without the blades installed to verify that motor and drivetrain dynamics and associated electrical loads would not interfere with the controller. Finally, blades were added, and the model was run in the hover configuration with GPC and AGPC active.

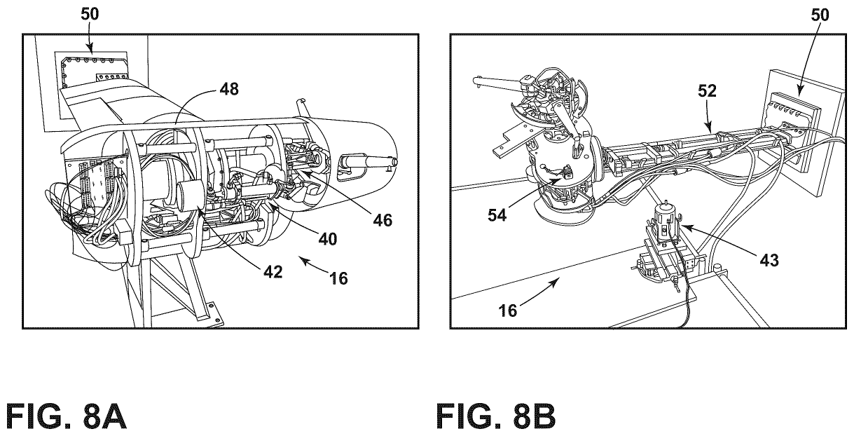

The TRAST model 16 with an inertial shaker 42 and external shaker 43 are shown in FIG. 8. The inertial shaker 42 has an internal mass that vibrates whereas the external shaker 43 is mounted to a stand with a rod directly connecting to the wing spar 52. Aerodynamic fairings were removed to allow the installation of the inertial shaker 42 and the external shaker 43 attachment rod. With the fairings removed, the natural frequencies of the system increase slightly.

In contrast to the simple tiltrotor model 20, the TRAST model 16 is precision manufactured and contains research-grade instrumentation. Instrumentation includes eight accelerometers (g) located in the engine nacelle, three accelerometers (g) in the wing, three LVDTs measuring swashplate actuator position (in), beam, chord, and torsion bending moment strain gauges (in-lbs) along the wing at three span locations, 9, 23, and 32 inches from the root, diaphragm spring gauges measuring strain (microstrain) at six locations, pitch spring force (lbs), azimuth encoder (deg), and various other rotor and drive train instruments measuring blade position and component loads as described in prior publications.

The first out of plane wing bending mode is about 5.1 Hz, the in-plane (chord) bending mode is about 6.8 Hz, and the pylon pitch mode is about 10.4 Hz with fairings installed in the nominal testing configuration. Nominal rotor speeds are 909 rpm in hover and 727 rpm in airplane mode.

GPC effectiveness and the ability of AGPC to improve controller performance was evaluated experimentally. For comparison, traditional GPC and AGPC performance is presented herein. Experimental results will first be shown for the simple tiltrotor model 20 and then for the TRAST model 16.

Test iterations of the simple tiltrotor model 20 consisted of the following procedure. All cyclic commands were zeroed, and the model swashplate was leveled using servo biases such that it was perpendicular to the rotor shaft. Model controls and operation were then verified. If needed, servo ratio gains were adjusted to maintain a level swashplate at all values of collective pitch. Blade pitch was adjusted to a positive value to encourage windmilling of the rotor system. Model instrumentation was tared to zero load/acceleration values, and the wind tunnel was brought online and slowly increased in velocity. There was no instrumentation available to measure rpm on the small model 20. Therefore, collective pitch was adjusted until visual and audible cues for rpm looked and sounded proper at a moderate wind-tunnel speed. Once set to an acceptable value, collective pitch was not adjusted as tunnel velocity was changed or the controller was engaged. The acceptable collective pitch and servo bias/ratio values were noted and were used for subsequent tunnel runs in order to conduct every run at the same nominal collective and cyclic values. As tunnel velocity increased, rotor rpm would also increase. At various velocity values from near idle until an instability was reached, system IDs were acquired, and closed-loop control was verified. At stable tunnel conditions that experienced minimal vibration or motion of the model, the closed-loop controller had almost no effect on the model response other than a slight reduction in vibration. The wind tunnel velocity was increased until an instability was encountered, or model limits were reached indicated by excessive drag deflection of the model. Once an instability was encountered, the tunnel velocity was slowed to a stable condition and a new system ID acquired. Then the adequacy of the closed-loop controller was tested as the model was returned to the unstable velocity. During some runs, attempts were made to acquire a new system ID beyond the flutter boundary, but these were usually unsuccessful as the model response was too large to enable identification of the effects of control inputs.

Testing revealed that a good system ID was one that was acquired at a sub-critical velocity (no flutter) with enough excitation to notably move the model but not so much as to cause the rotor disk to stall, diverge, or otherwise change the inflow velocity. Additionally, early GPC attempts resulted in the controller commanding aggressive collective commands to essentially stop the rotor. While this did quell vibration to near-zero values, it is not the intent of the controller. Therefore, during testing, a large weighting penalty was applied to collective commands in order to favor cyclic inputs as a solution to vibration reduction. With the larger penalty on collective, the adaptive controller implemented negligible change to collective and rotor rpm.

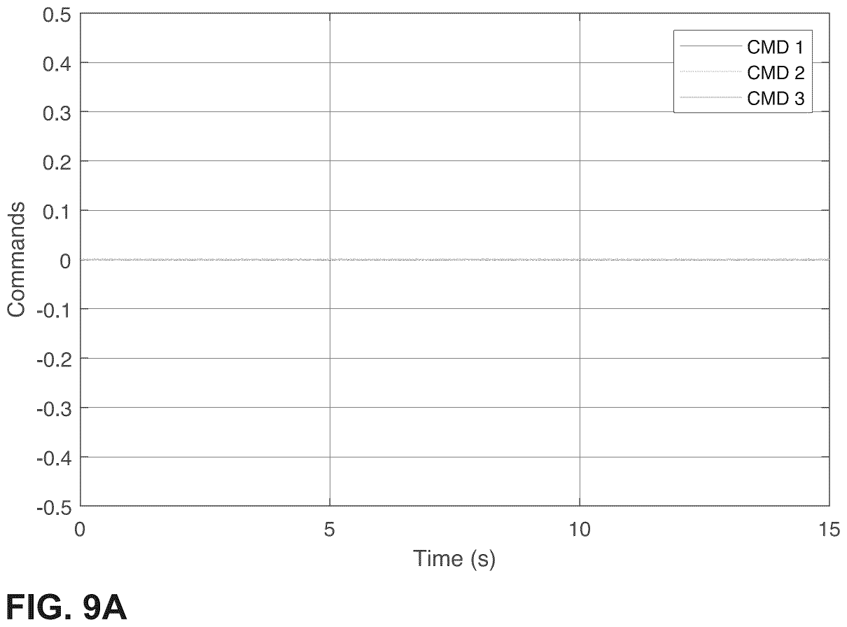

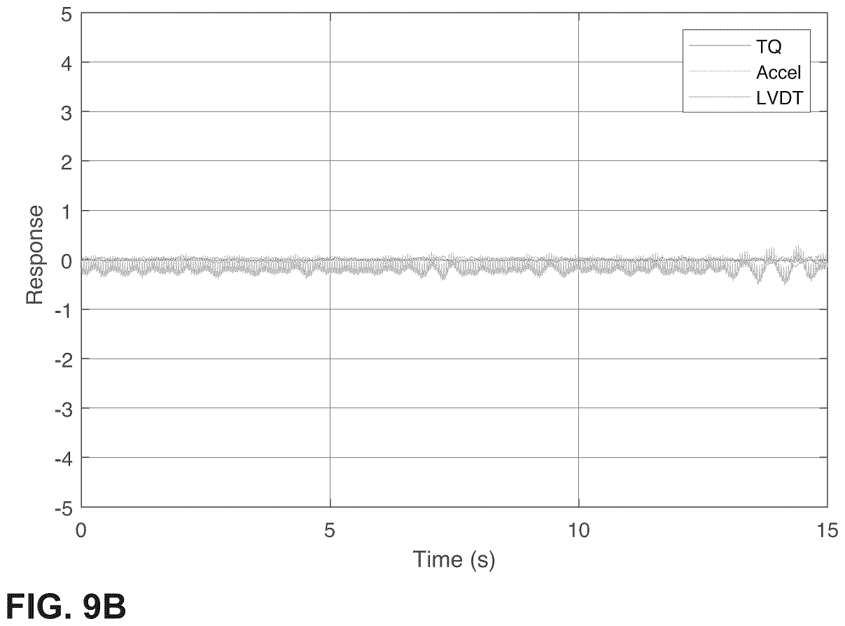

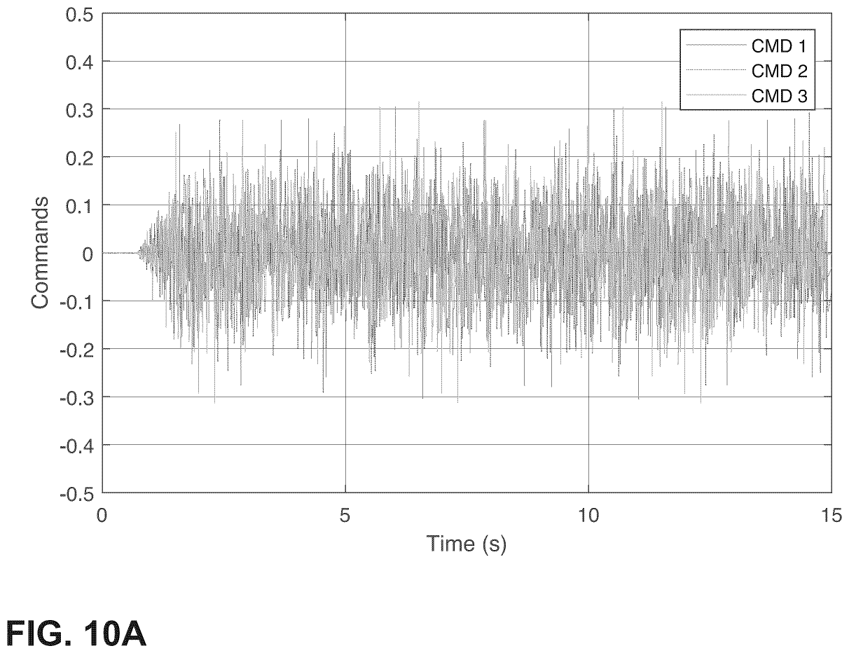

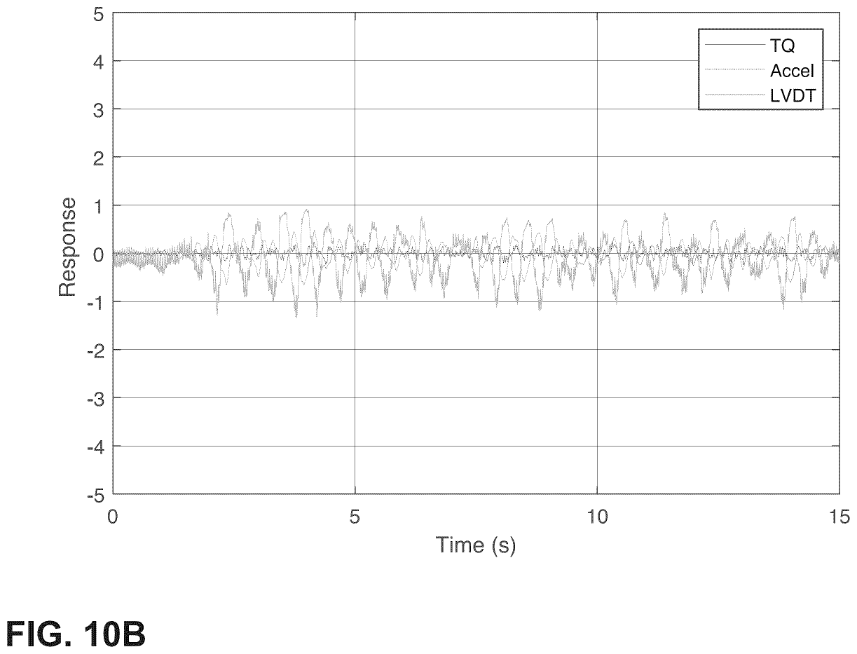

FIGS. 9A, 9B show an example of the open-loop response for an equivalent airspeed of 19.06 ft/s with a nominal collective setting. In this model configuration, the LVDT is attached, a fore-aft accelerometer is installed, and the torque transducer is attached at the model base. Additionally, the control rod linkages are in their nominal configuration to instigate a whirl-flutter instability at low velocity. The tunnel condition of 19.06 ft/s is just below the whirl-flutter boundary, and some small oscillations are starting to beat in and out during the time history as shown in FIGS. 9A, 9B. The response measurements are g's of acceleration for the accelerometer and arbitrary values for the torque transducer and LVDT scaled to have peak responses of similar magnitude. The command signals are voltage of command output. Similarly, FIGS. 10A, 10B show a time history of the system ID excitation and response acquired at a velocity of 19.06 ft/s.

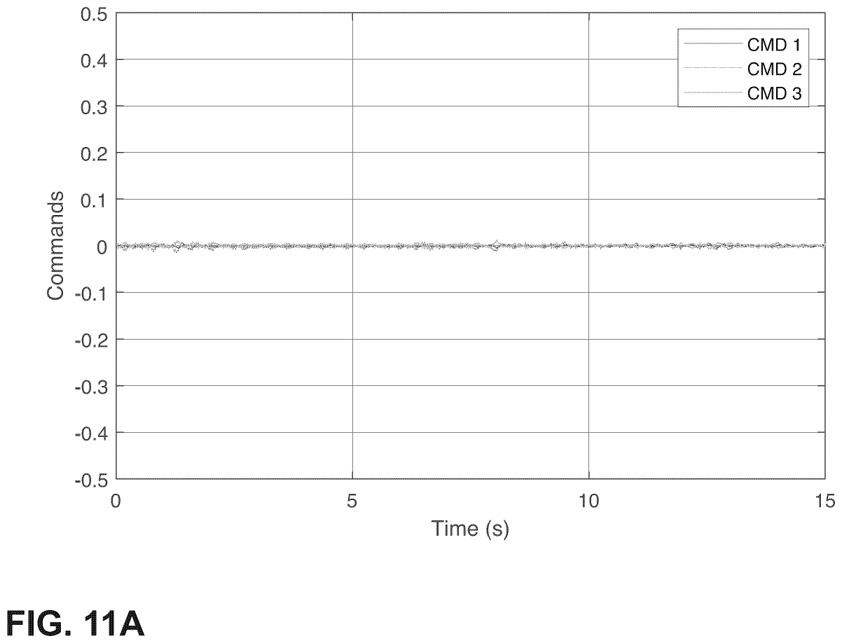

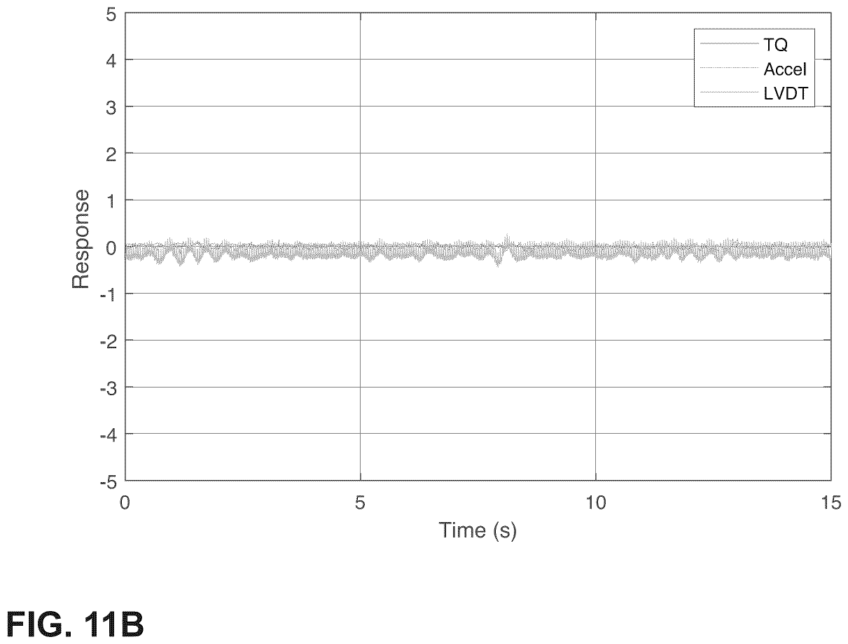

The closed-loop response following the system ID is shown in FIGS. 11A and 11B. By comparison with FIGS. 9A, 9B, it can be seen that the dynamic response is slightly reduced. A significant change is the reduction of the low frequency bursting observed near the end of the time history in the open-loop response.

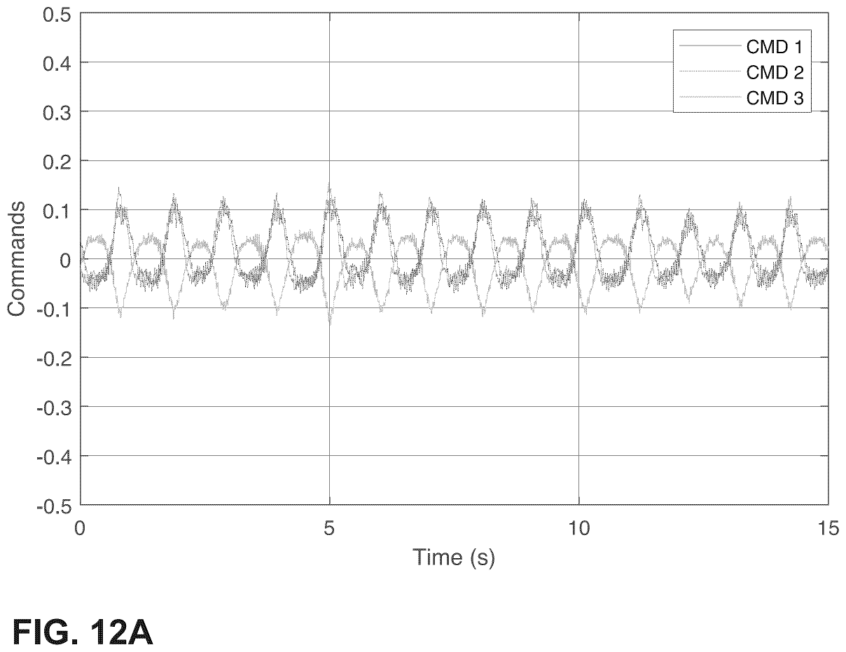

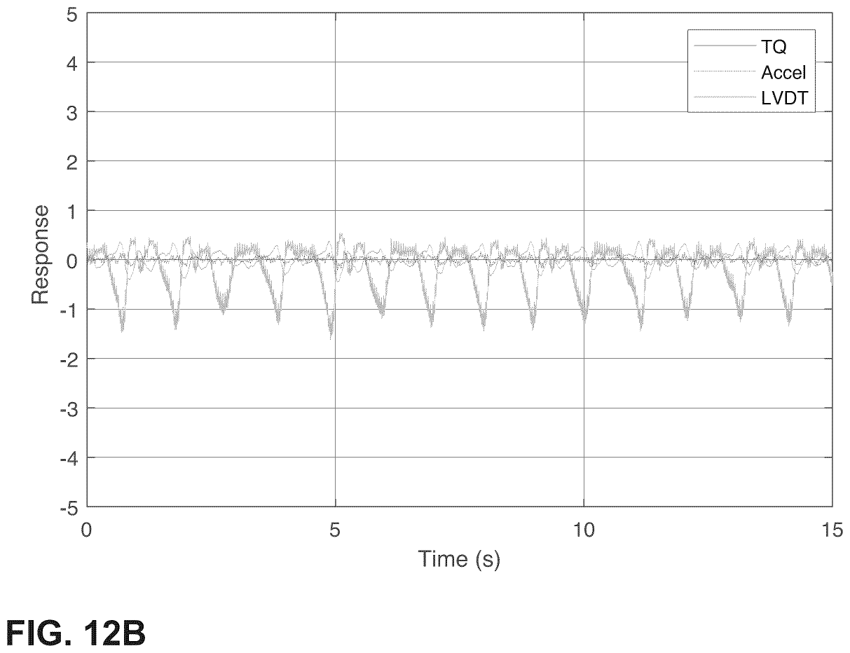

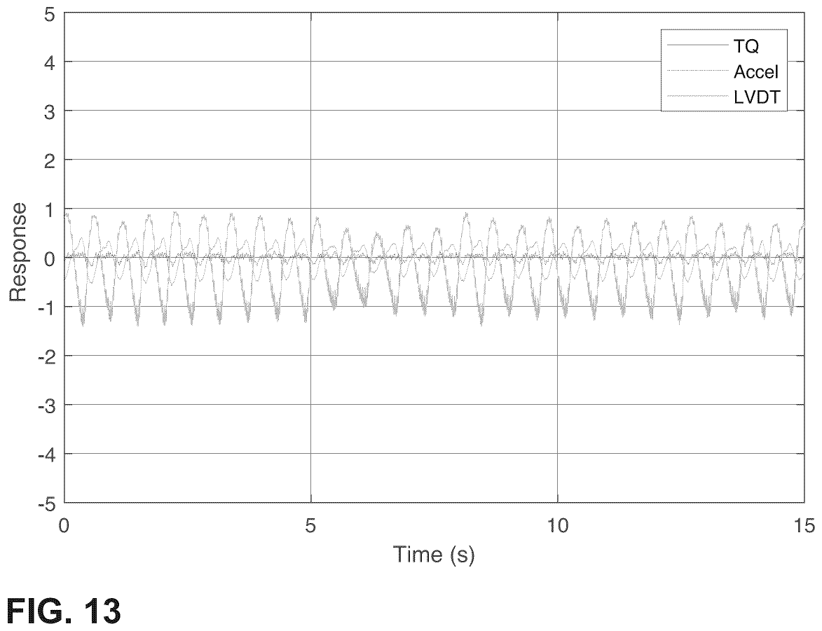

The effectiveness of the GPC controller during testing was reduced as the model crosses the stability boundary and the system dynamics change considerably. This can be partially explained by difficulty in acquiring a good system ID with the highly non-linear system and challenges associated with the small-scale instrumentation and model quality. For example, the geometry of the yaw LVDT attachment results in highly nonlinear measurement of nacelle yaw that is heavily coupled with wing pitch. FIGS. 12A, 12B shows a time history plot of the closed-loop response of the system in the supercritical flutter condition at 21.17 ft/s with a system ID acquired at 19.06 ft/s. In this figure, the LVDT signal has many repeating spikes showing a periodic yaw-divergence of the system. The controller is struggling to stop this motion, but other dynamics have been suppressed. By comparison, the open-loop response of the model is shown in FIGS. 13A, 13B. The command signal is zero for this condition similar to the open-loop response shown in FIGS. 9A, 9B, so the plot is not included here. The open-loop response exhibits a large peak-to-peak magnitude of the LVDT measuring nacelle yaw that fluctuates both positive and negative. Additionally, the open-loop response has significant motion of the torque transducer indicating periodic motion of the wing in pitch. This open-loop response resembles a classic whirl-flutter behavior. While the GPC controller is performing poorly, it is able to suppress the whirl motion. Better measurement of the nacelle yaw motion may result in better controller performance.

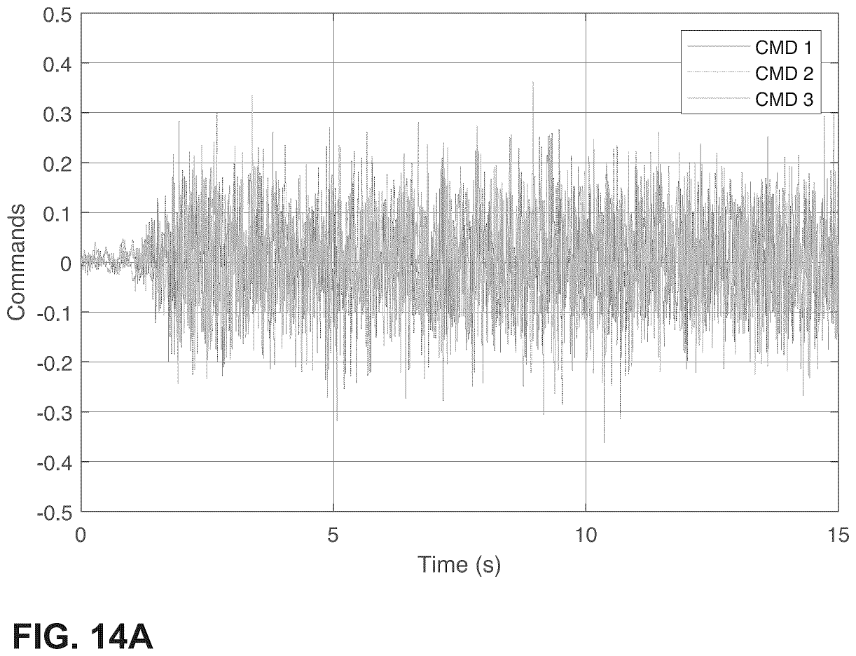

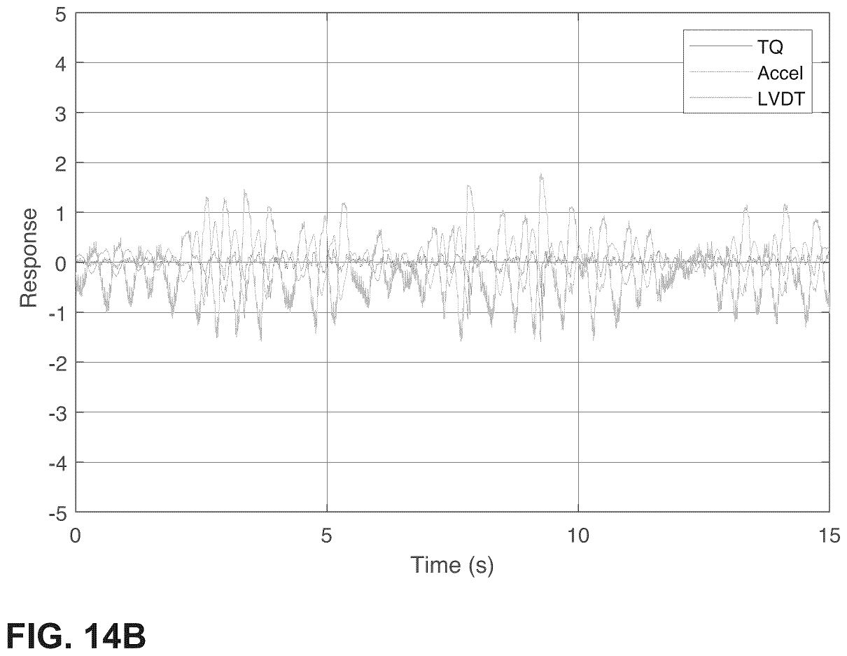

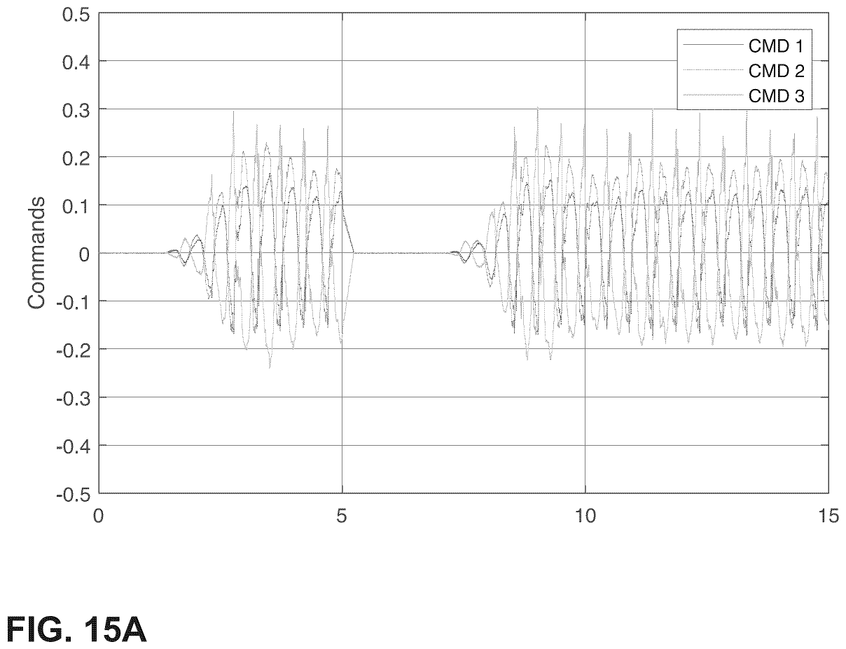

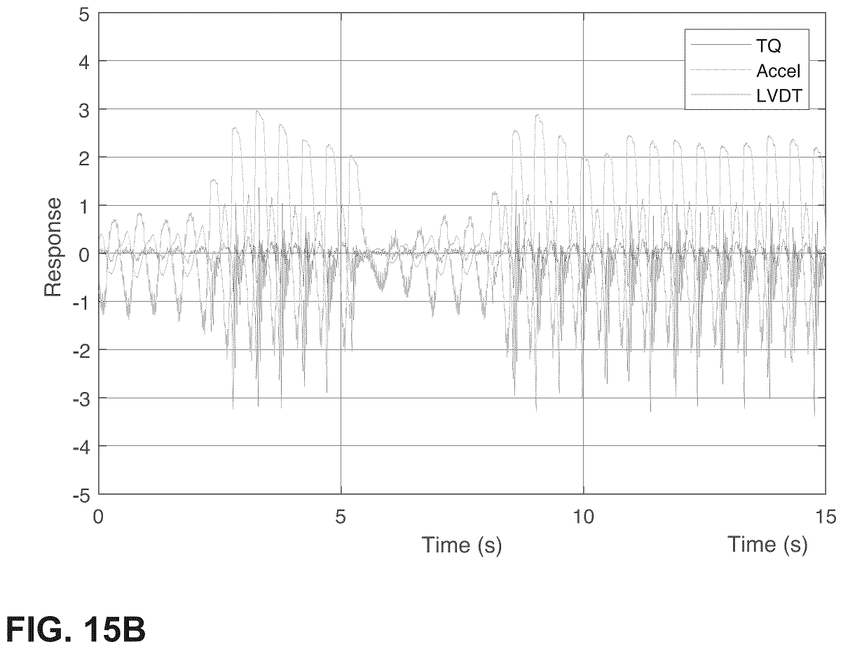

To improve controller performance, a new system ID was acquired at 21.17 ft/s with the controller already closed loop with the previous system ID acquired at 19.06 ft/s. The system ID time history is shown in FIGS. 14A, 14B, and the closed-loop response of the system with the updated parameters is shown in FIGS. 15A, 15B. During this time history, the controller was turned on and off to verify the change in response due to the controller input. As observed, the controller is not able to stabilize the system at this condition. The dynamics of the instability are too overwhelming to allow the signal-to-noise ratio required to acquire a good system ID. Multiple attempts were made, but the controller performance could not be improved at this condition with traditional means.

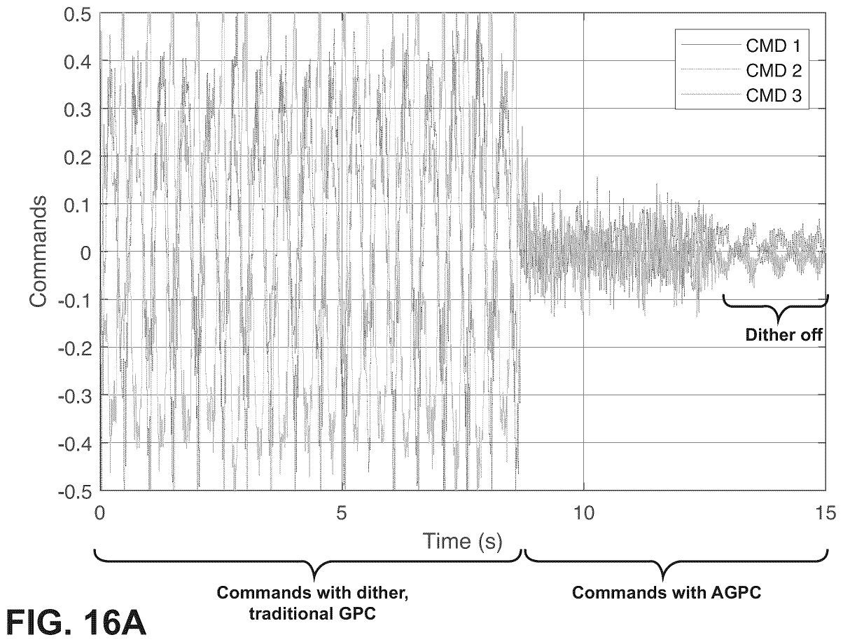

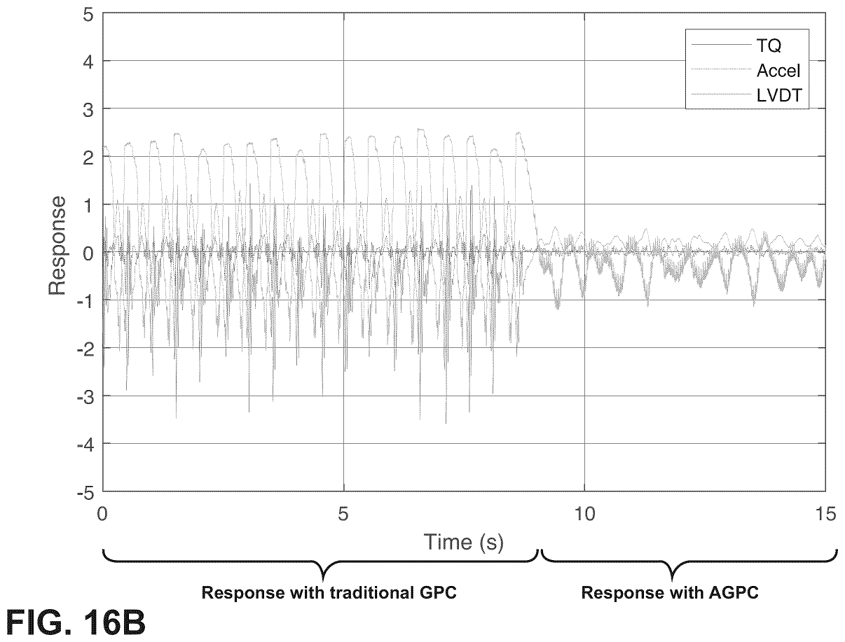

During testing, AGPC was applied experimentally to improve the controller response. AGPC was employed first as a traditional GPC controller while observing the input-output behavior to compute errors in the OMP matrices. For this example, traditional GPC was operating using the system ID previously described and operational in FIGS. 15A, 15B. During this employment of AGPC, the figures of merit were not favorable indicating that the commands were not independent enough from one another using the natural closed-loop command and response signals. Therefore, dither was added to the commands until the figures of merit were at adequate levels approaching those achieved during the sub-critical system ID. A time history of the closed-loop controller with dither added is shown in FIGS. 16A, 16B using orthogonal multisine excitation added to the natural closed-loop commands. The first part of the time history uses the same system ID matrices as those used for the closed-loop response previously shown in FIGS. 15A, 15B. As command excitation is increased, due to the addition of dither, from peak values near approximately 0.3 in FIGS. 15A, 15B to peak values near approximately 0.5 in FIGS. 16A, 16B. Despite the addition of the dither, the response magnitude of the system is approximately the same, indicating that the dither has a negligible impact on system response yet significantly improves the figures of merit. The latter part of this time history is with the new controller produced from the AGPC self-correcting algorithm applied, at first with dither still active and finally with the dither stopped. Again, one can observe that the dither has a negligible effect on system response. The advantage of AGPC is apparent in FIGS. 16A, 16B and its performance outperforms traditional GPC even when the system ID for traditional GPC is attempted at the same condition. In this example, only AGPC could stabilize the system where traditional GPC methods failed despite efforts to acquire new system IDs.

The time history presented in FIGS. 16A, 16B is an example of a favorable self-adaptation attempt where the new OMP matrices are immediately applied to the model as soon as they are calculated by the AGPC algorithm. Other attempts were not as successful during earlier testing, and the control commands quickly became violent. Thus, for testing purposes, self-adaptive control changes computed by AGPC were hereafter applied to a controller OMP matrix set that was not in use. Manual mixing of the matrix sets was then done to enable a slow transition from one matrix set to another allowing the investigator to observe the change in system performance before committing to the self-adaptive AGPC controller update.

During experimental efforts, there were other instances where traditional GPC was able to stabilize the whirl-flutter instability of the simple tiltrotor model. However, most of these occurrences were earlier in the test effort prior to the installation of the LVDT and often resulted in static yaw divergence of the nacelle. After testing of simple model 20, the research effort shifted focus to the TRAST model 16, which was precision machined, contains instrumentation of scientific quality, has reliable and repeatable actuators, is fully supported by research staff, has quality signal conditioners and data system components. Also, the TRAST model 16 is closely related to the tiltrotor aircraft 1 (FIG. 1).

Applying an active control system to a complex rotorcraft model may involve an incremental approach due to the risk to the model and facility during testing. Thus, during testing, application of GPC and AGPC to the TRAST model 16 was done first on the model 16 with no blades and no rotation of the rotor system. The only control effector in this configuration was the mass of the swashplate and the resulting risk to model systems in this configuration was minimal. Once the controller and safety protocols proved satisfactory, the rotor system was rotated without the blades installed to verify that motor and drivetrain dynamics and associated electrical loads would not interfere with the controller. Finally, blades were added, and the model 16 was run in the hover configuration with GPC and AGPC active.

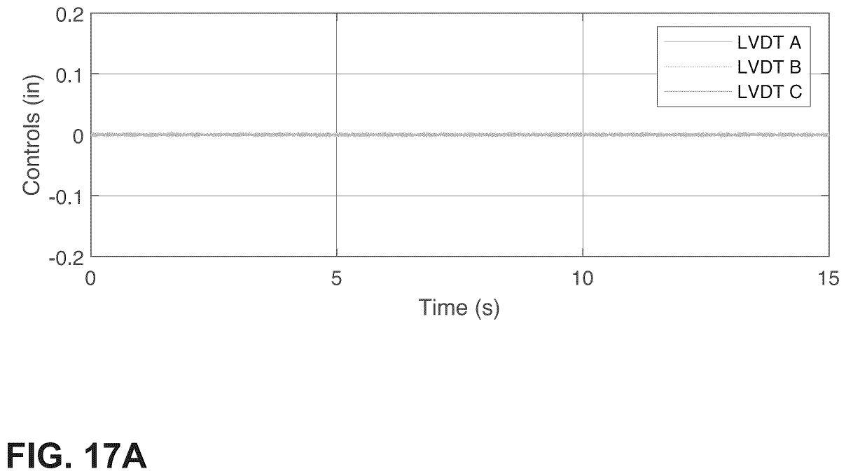

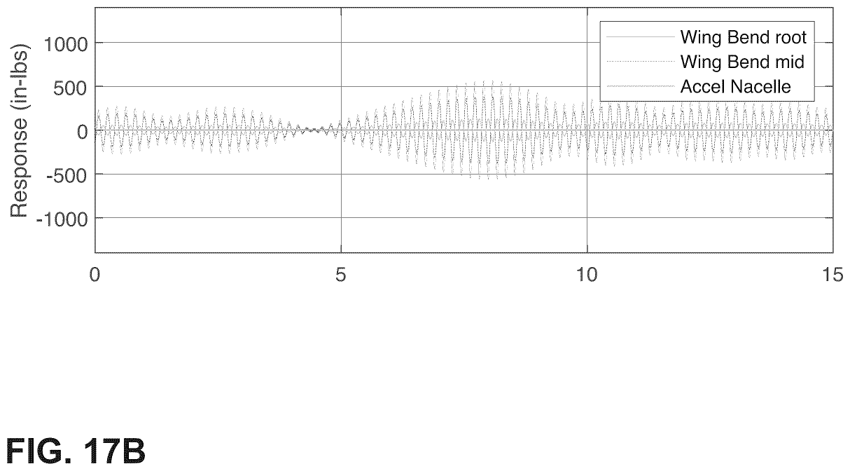

The first test iterations were done in the helicopter mode with an inertial shaker using an internal vibrating mass operating in a sine sweep from 4.5 to 15 Hz over a period of 15 seconds. All three of the primary modes described earlier (wing out-of-plane bending, wing in-plane chord bending, and nacelle pitch) were excited by the shaker. Data records were acquired for a period of 15 seconds in order to capture the full sweep. Data records were manually triggered independent of the shaker commands and were started at times arbitrary to the period of the shaker sweep. The open-loop response of the TRAST model 16 is shown in FIGS. 17A, 17B.

Initial attempts of applying GPC to the TRAST model 16 involved using wing root bending, wing root chord, and nacelle pitch bending moment measurements and controls of collective, longitudinal, and lateral cyclic. However, in the helicopter mode at 90-degree nacelle angle using only the mass of the swashplate as an effector, cyclic controls are not capable of affecting wing chord or nacelle pitch modes. Therefore, the system ID characterized the response of signal noise to cyclic input rather than actual system behavior. As a result, the closed-loop response was violent and unstable. When individual actuator positions were used as the controls and the measured response was wing root out-of-plane bending, mid-span wing out-of-plane bending, and nacelle acceleration (aligned with the rotor shaft), then GPC performance was very effective. Thus, the selected control actuators should be able to effectively influence the measured response or GPC may not be effective.

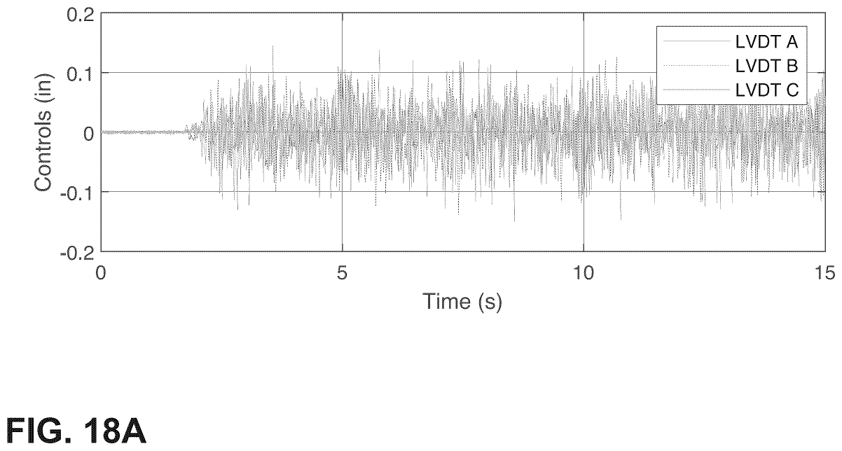

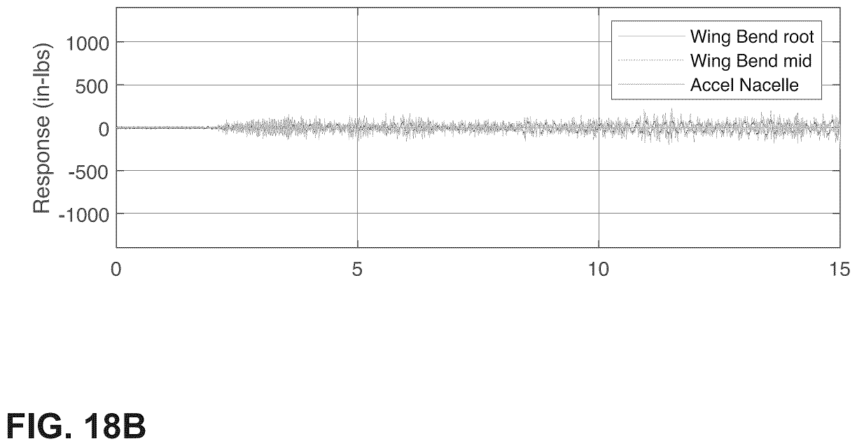

An example of a system ID time history with orthogonal multisine excitation and the individual actuator positions as control input is shown in FIGS. 18A, 18B. For the system ID, the inertial shaker was turned off since it created more vibration than the mass of the swashplate was able to excite.

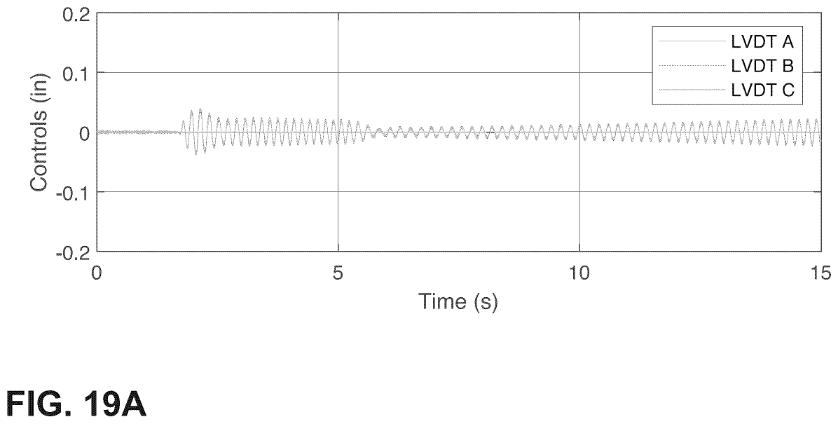

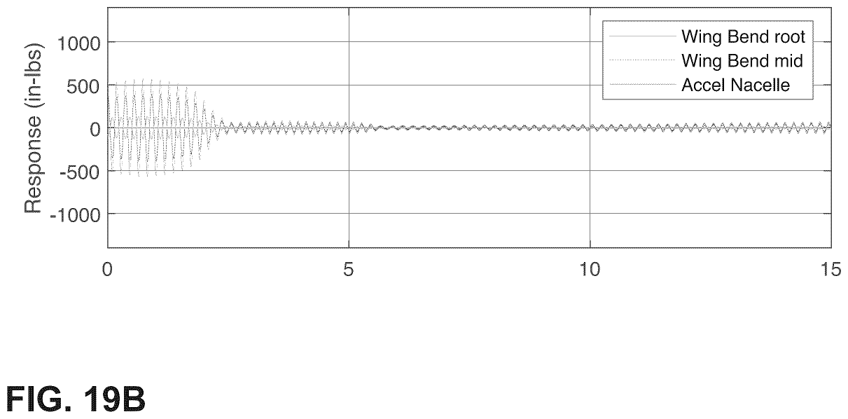

Closed-loop time history data are shown in FIGS. 19A, 19B using this system ID. In this example, the system is initially open loop, and the controller is activated after the shaker excites the bending mode in resonance. As seen, the GPC controller is very effective at nearly eliminating the vibration from the inertial shaker. The increase in instrumentation quality and the ability of the actuators to influence the measured quantities has substantially improved the controller performance by comparison to the simple tiltrotor model. Additionally, by inspection of the LVDT command signals, it can be seen that the actuators are in unison inciting a collective response of the swashplate as one may expect.

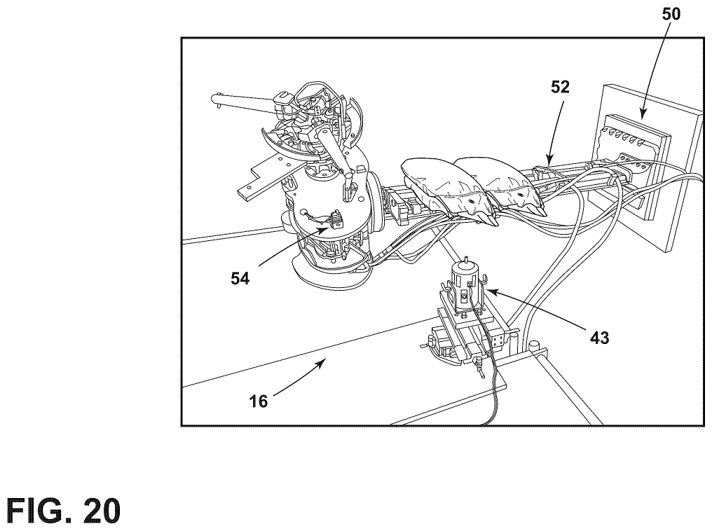

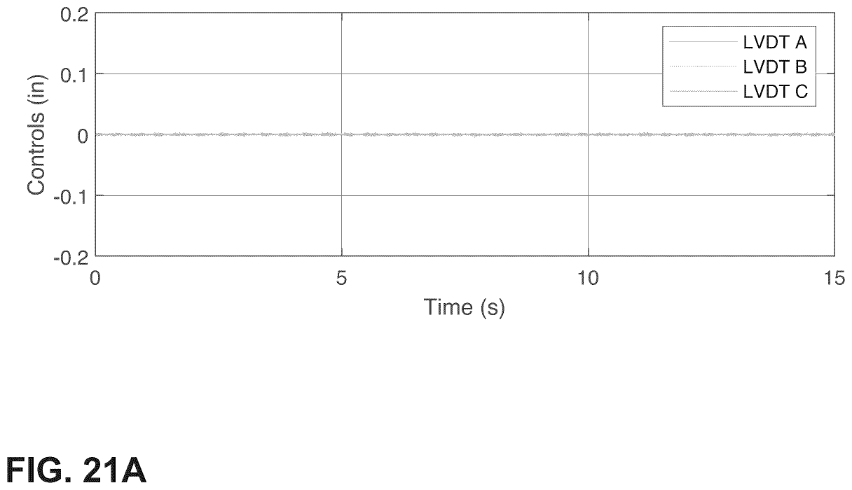

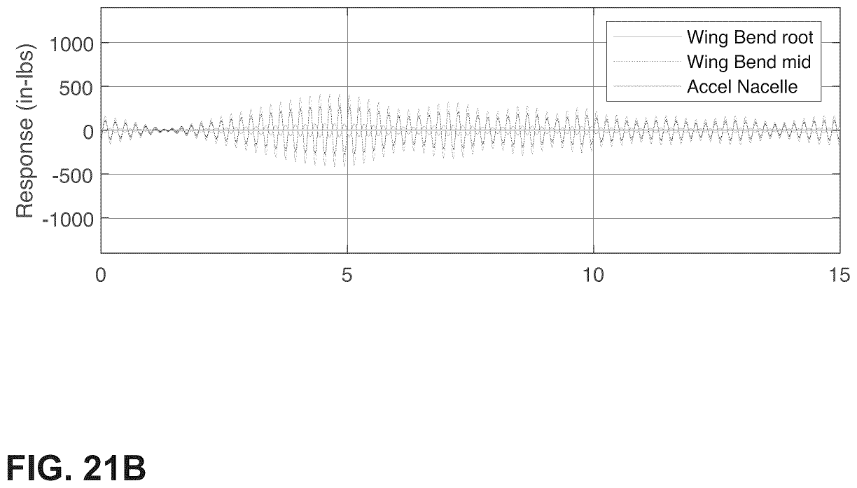

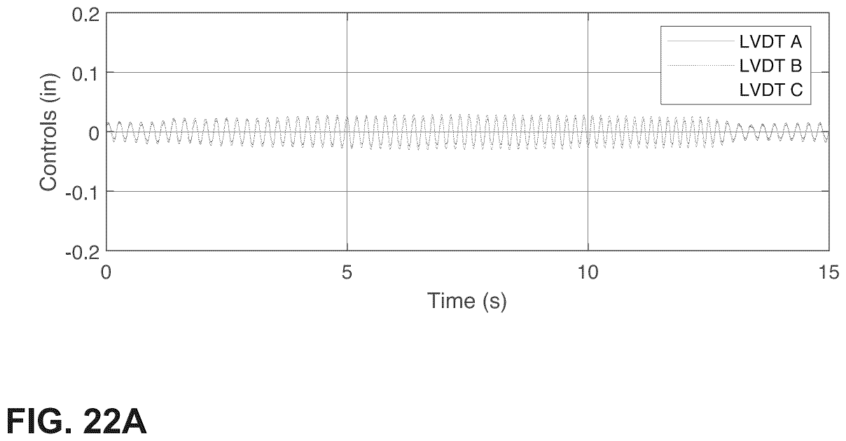

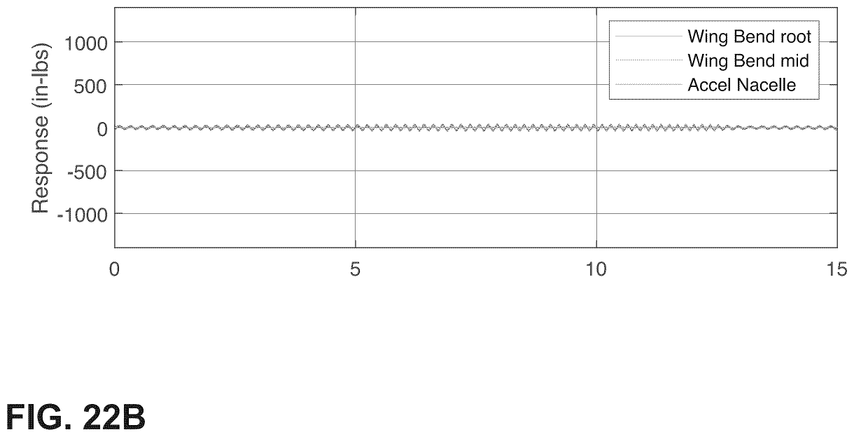

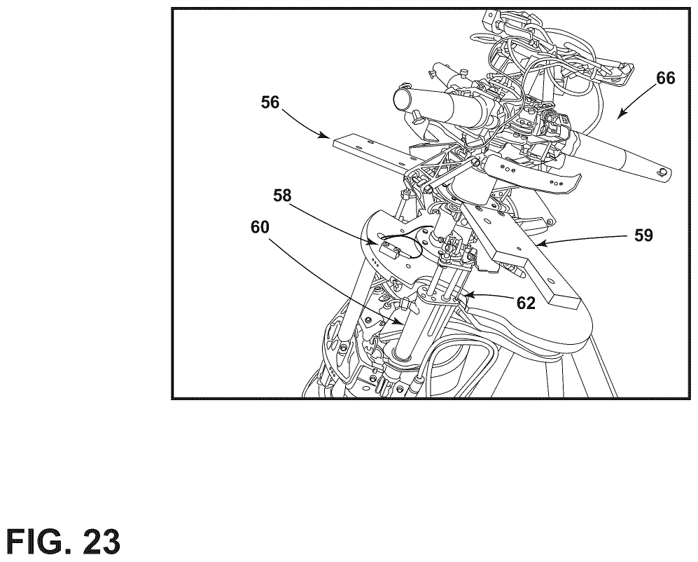

To experiment with the robustness of the controller, a series of 14-pound sandbags were added to the wing as shown in FIG. 20 in order to alter the natural bending frequency of the model. The nominal wing out-of-plane bending frequency was approximately 5.5 Hz with the fairings removed as shown and was reduced to 5.0 Hz with three sandbags (42 pounds) in place. The frequency sweep used on the inertial shaker was reduced in bandwidth to better target the first bending mode and ran from approximately 4.5 to 6 Hz. Recall, the open-loop response with no sandbags was shown in FIGS. 17A, 17B and the response with three sandbags added is shown in FIGS. 21A, 21B. The addition of the sandbags increased the inertia of the system and reduced the amplitude of the response. The closed-loop response of the system with sandbags using the same system ID acquired without sandbags is shown in FIGS. 22A, 22B. The addition of the sandbags resulted in no degradation of the controller performance even though the natural frequency and mass of the system are different.

Predominant aeroelastic modes of the TRAST model 16 during wind-on testing typically involve out-of-plane wing bending, in-plane (chord) wing bending, and pylon pitch modes. However, the rotor-off testing described above was limited to control of the out-of-plane wing bending mode only due to the orientation of the nacelle and limited use of swashplate mass to suppress vibrations. In an effort to control additional modes of vibration, the nacelle was positioned in a transient position (transitioning between airplane and helicopter mode) (FIG. 23) at approximately 60 degrees to the horizontal so that swashplate motion could affect wing out-of-plane bending and chord modes. Additionally, two large irregular masses 56, 57 were added to the rotating frame of the swashplate in lieu of pitch-change (PC) link connections. These masses 56, 57 were placed 120-degrees apart where the PC links would be for two of the three blades and the rotor was rotated to a position such that the masses could influence pylon pitch and yaw motion. Each mass differed in geometry and were one pound and two pounds respectively in weight. These masses 56, 57 were placed to give more control authority in an off-axis directions using swashplate cyclic motion. The tilted nacelle and arbitrary masses is shown in FIG. 23. The LVDT 62 associated with hydraulic actuators 60 is more visible than previous drawings in addition to the swashplate and scissor assemblies being more visible.

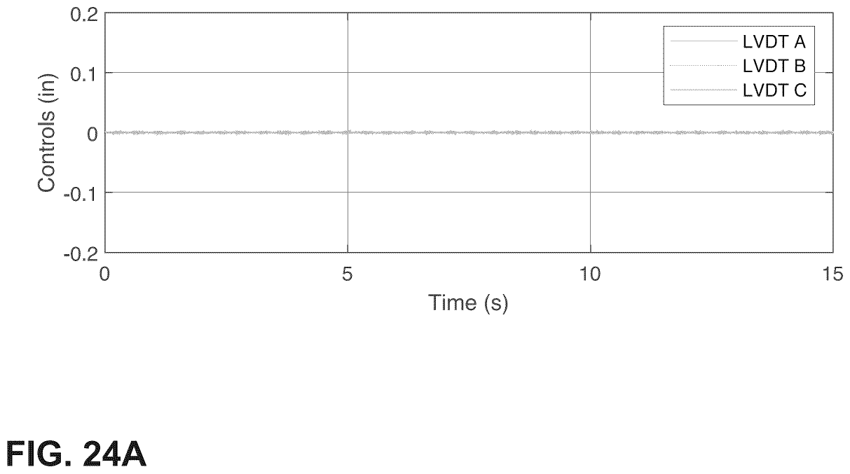

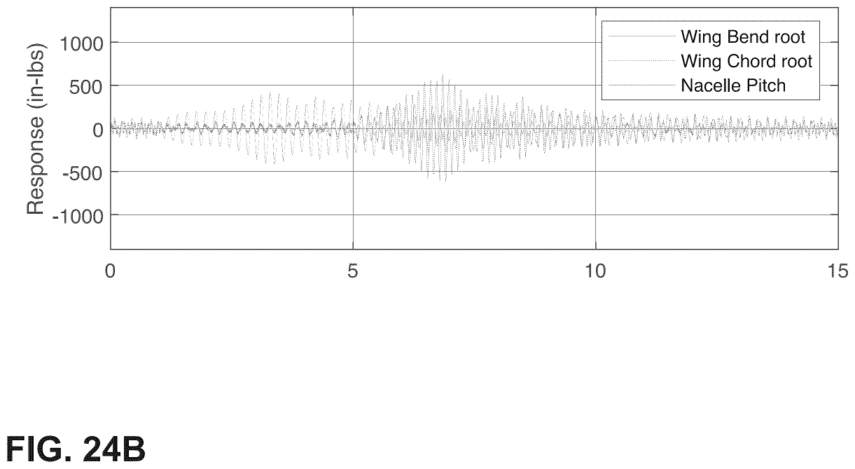

In the configuration of FIG. 23, the inertial shaker was mounted to the pylon in the same orientation (relative to the pylon) as before such that the vibrating mass induces forces along the pylon axis parallel to the rotor shaft 60 degrees from the horizontal. The inertial shaker will therefore excite wing bending and wing chord modes. However, its effect on pylon pitch is comparable to other nacelle orientations and does not excite the mode appreciably. FIGS. 24A, 24B show a time history of the open-loop shaker sweep from 4.5 to 15 Hz over a period of 15 seconds as done previously for the model in the helicopter mode. From this time history, it can be seen that the wing chord mode is now a dominant response in addition to the wing bending mode. Nacelle pitch is also excited slightly but is a very small response compared to the wing modes due to the orientation of the shaker.

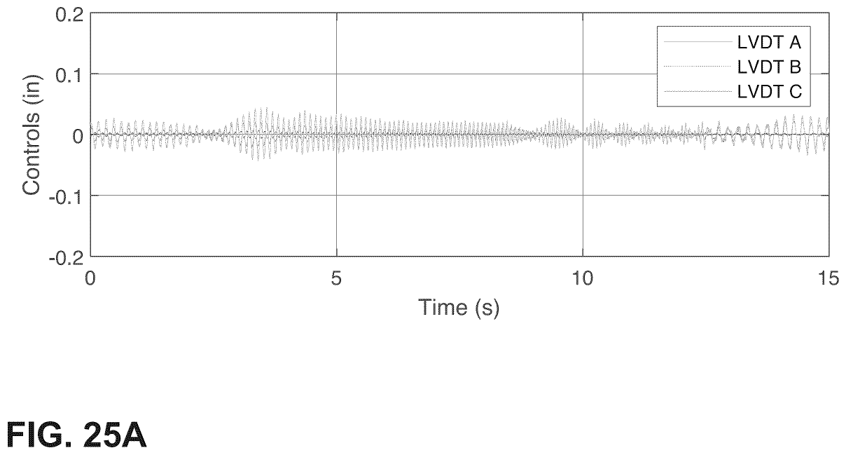

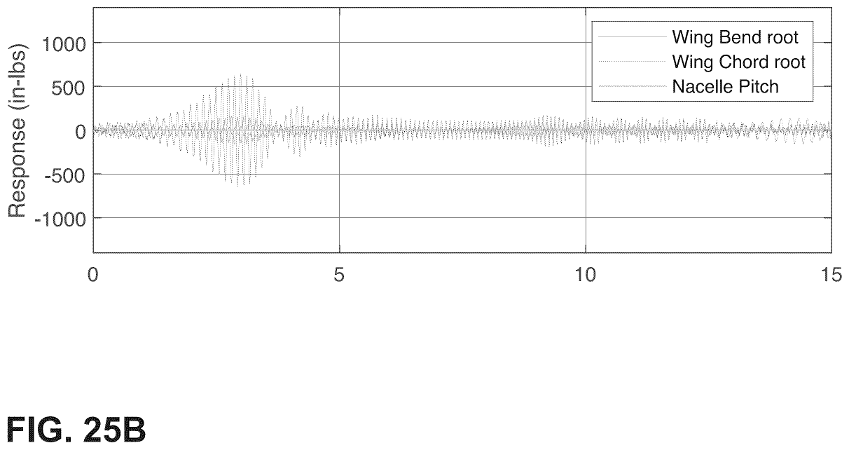

During this testing, system ID data were acquired using orthogonal multisine excitation in the same manner previously described for the model in the helicopter mode, but using wing out-of-plane bending, in-plane chord bending, and nacelle pitch strain gauges as response measurements. The closed-loop response using traditional GPC following the system ID is shown in FIGS. 25A, 25B. In this response, the wing out-of-plane bending is almost entirely suppressed, but there is negligible impact on the wing chord mode. Also, the actuator response is no longer a symmetrical collective input, but rather an asymmetrical cyclic input. Finally, the data acquisitions for the open-loop and closed-loop responses were taken at arbitrary start times during continuous shaker sine sweep loops, and FIGS. 24A, 24B should not be compared to FIGS. 25A, 25B as indicated by the different time periods of the resonant wing chord response.

During further testing, to simulate a dynamically unstable aeroelastic event, an external shaker 43 (FIG. 20) was connected to the wing using a pushrod and was commanded using a control-feedback loop. The out-of-plane bending moment of the wing was measured and the shaker applied a force proportional to the derivative of the load (proportional to velocity) and in the direction of the displacement simulating a negative viscous damping. If left unaltered, the amplitude of the wing would grow exponentially until reaching a shaker limit. This creates an artificial “negative” damping or dynamic instability that mimics the behavior of flutter with an equivalent value of damping coefficient equal to 0.007.

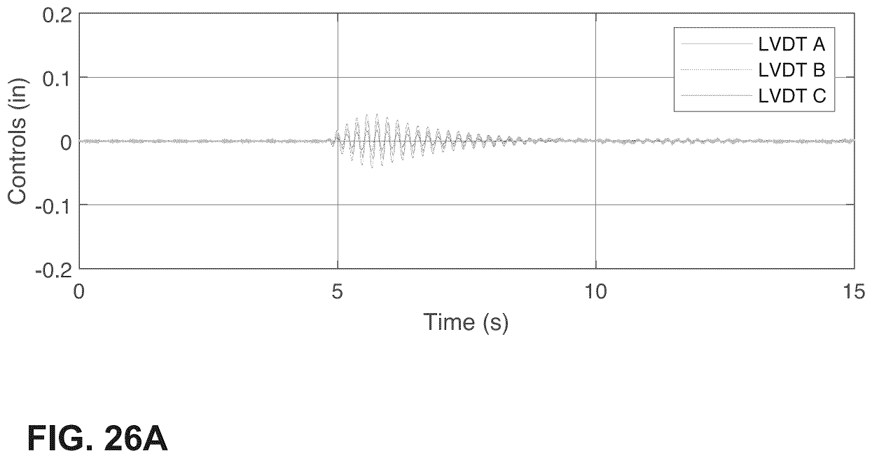

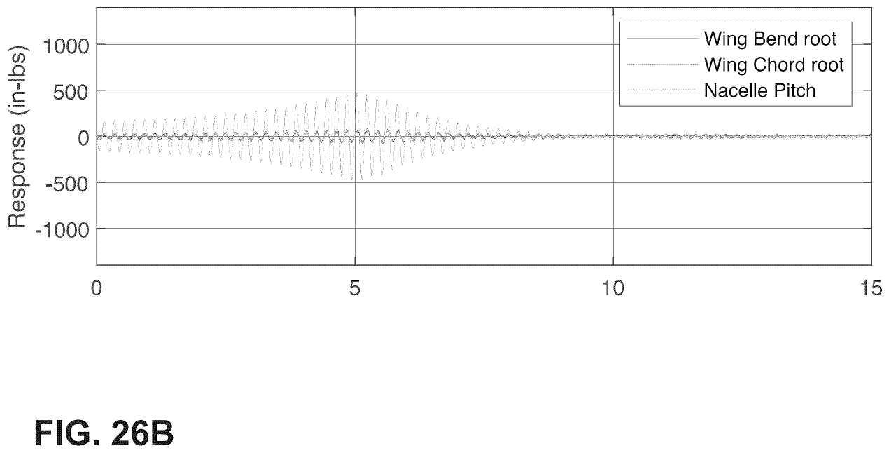

GPC was then employed using the same mass of the swashplate and arbitrary masses as the control actuator. Time history data with the external shaker feedback loop is shown in FIGS. 26A, 26B for the TRAST model 16 with the nacelle at 60 degrees. The first five seconds of the time history is open loop with the GPC controller inactive. During the open-loop portion, the exponential growth of the wing bending mode is apparent. If allowed to continue, load capability of the shaker would be exceeded, and the dynamic growth would be limited. However, at approximately five seconds, the GPC controller was activated, and swashplate actuation dampened the response of the wing. It can be seen that traditional GPC is effective at stabilizing the instability. Consistent with past experiences, active controls may be more effective at stabilizing an instability than they are at reducing vibration and can do so with less control authority.

During further testing, following the successful application of GPC to the TRAST model 16 without the rotor installed and the development and application of various model safety protocols as described above, GPC was then applied to the model 16 with the rotor installed and operational. Before blades were added, the arbitrary weights were removed from the swashplate and the PC links reattached to the blade pitch horns. Additionally, prior to blade installation, the controller was tested with the rotor hub spinning and no blades attached to verify that the electrical drive noise and pilot commands would not interfere with the GPC controller. The inertial shaker was then engaged and results similar to those presented earlier were acquired confirming the performance of the controller in the presence of the operating drivetrain.

For the TRAST model 16, the nominal rotor speeds are 909 rpm in hover and 727 rpm in airplane cruise mode as previously mentioned. During rotor runup, the out-of-plane bending mode of the wing is excited at 300 rpm and the wing chord bending mode is excited at 680 rpm. With a properly balanced rotor system, the model 16 can dwell at these rotor speeds without danger to the model 6, but the vibrations are significant and serve as a suitable testbed for GPC vibration reduction. Also, the vibrations are significant enough that a system ID at these conditions is unlikely to be successful because of the signal to noise ratio.

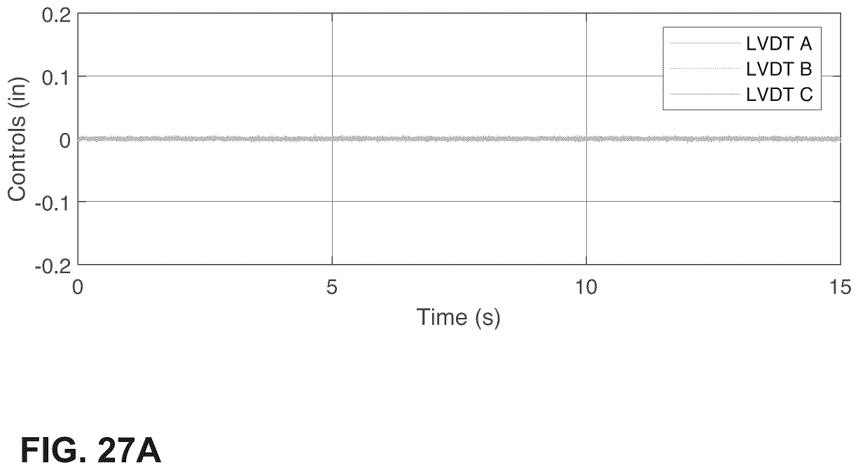

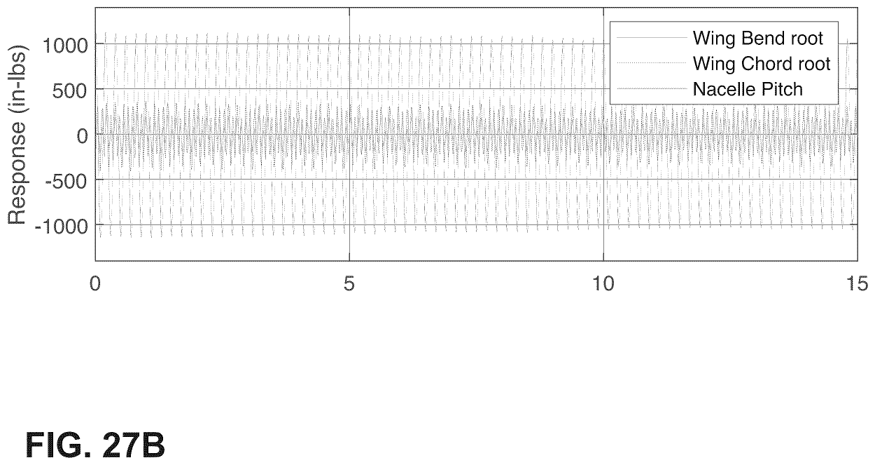

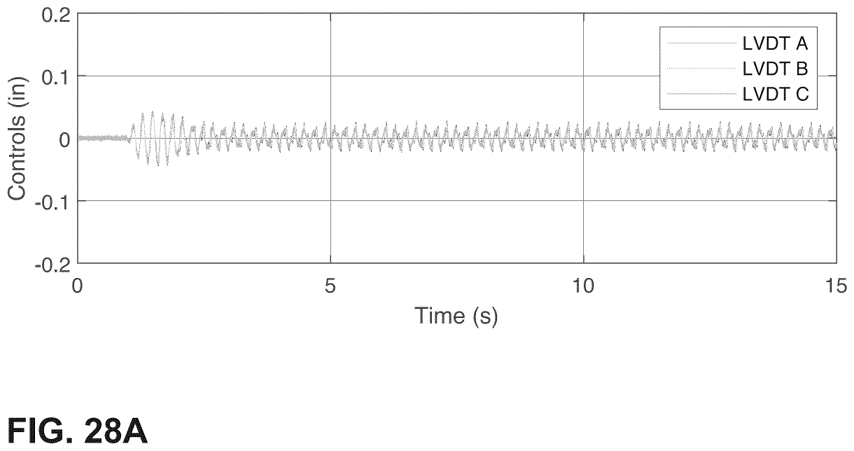

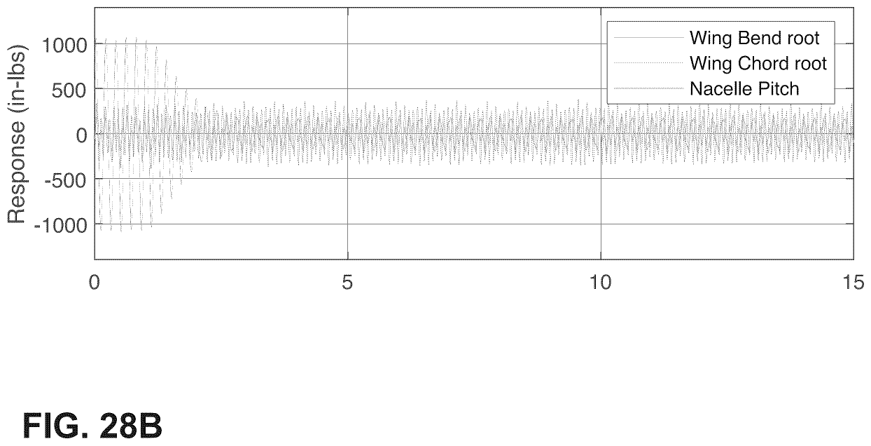

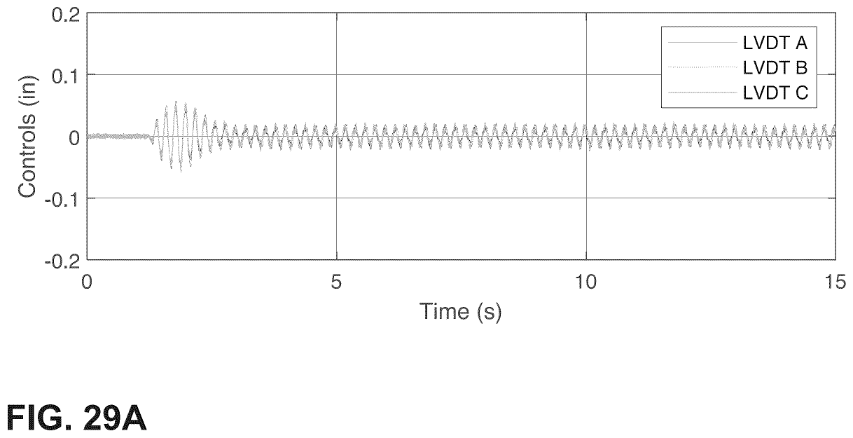

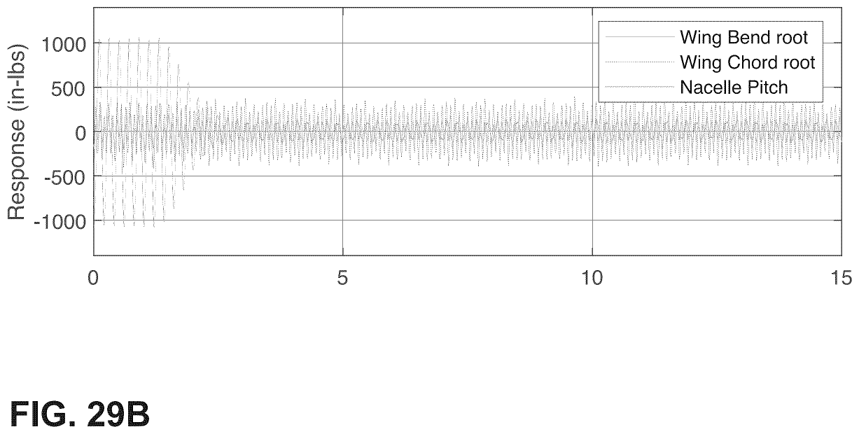

System ID data were acquired at 270 rpm and 500 rpm thereby bracketing the out-of-plane bending resonance encountered at 300 rpm. The steady state open-loop response of the TRAST at 300 rpm in the helicopter mode is shown in FIGS. 27A, 27B. Similarly, the closed-loop response of the model with system ID data acquired at 500 rpm and 270 rpm are shown in FIGS. 28A, 28B and FIGS. 29A, 29B respectively. For both of these data records, the time history begins open loop, and the loop is closed after approximately two seconds.

Both system IDs from 270 or 500 rpm are effective at suppressing the wing bending response and exhibit similar steady state vibration. However, the controller using the system ID acquired at 270 rpm suppresses the bending mode noticeably faster than the controller using the system ID acquired at 500 rpm. This is because the behavior of the model at 270 rpm is more representative of the behavior at 300 rpm than 500 rpm. Traditional GPC was also tested at various other rotor speed conditions with and without the inertial shaker yielding similar results to those presented without the rotor.

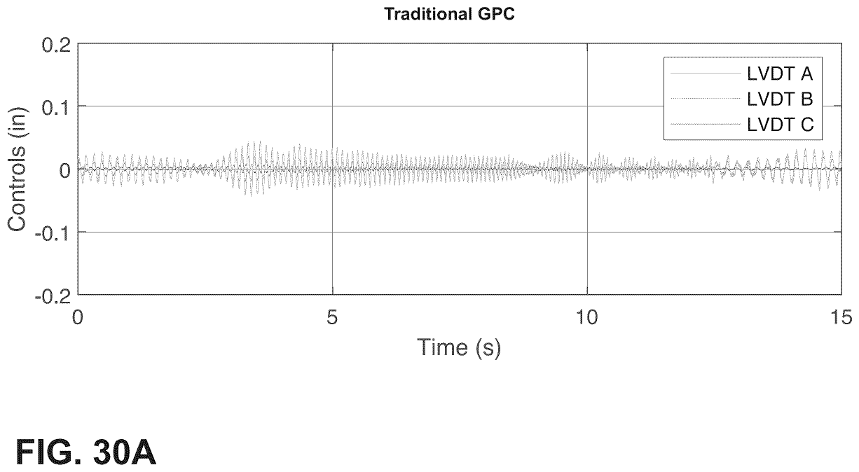

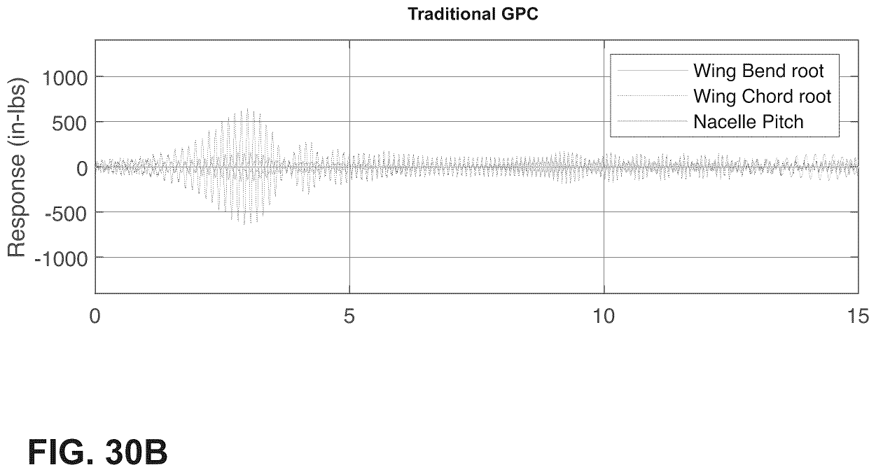

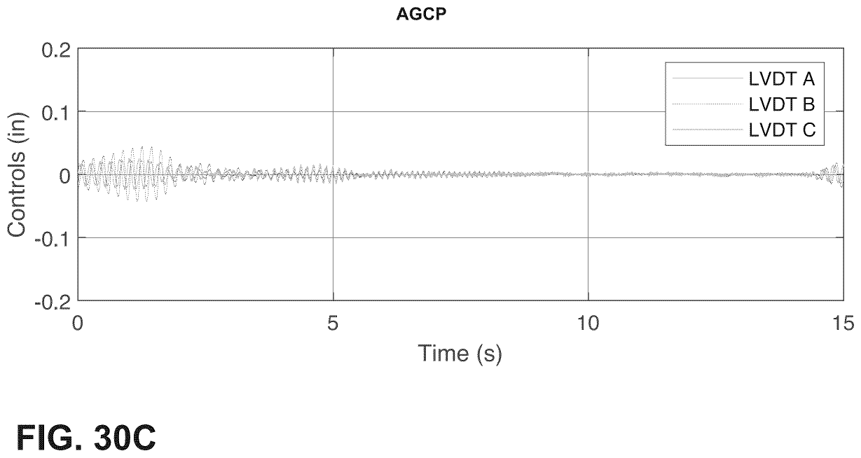

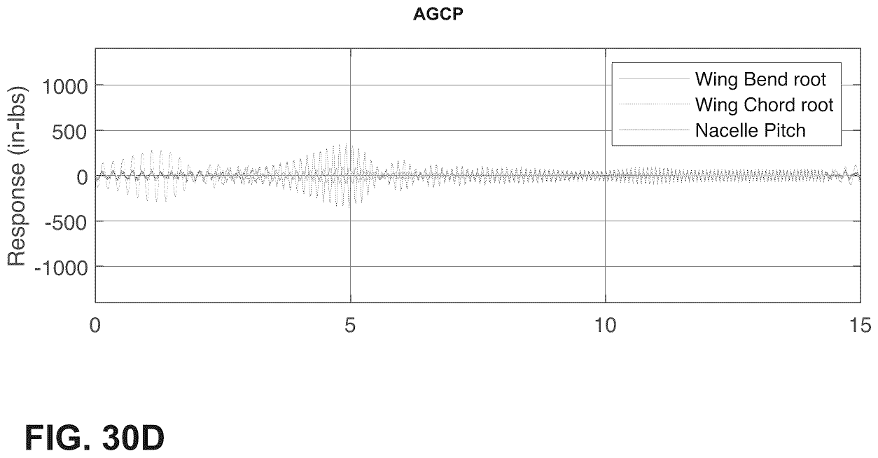

There are some conditions in the previous traditional GPC examples that lend themselves to testing the performance improvement potential of AGPC. The first case is the inertial shaker with the nacelle at 60 degrees and arbitrary masses installed on the swashplate. The result of AGPC compared to the previously presented traditional GPC performance for the model in this configuration is shown in FIGS. 30A-30D. AGPC significantly improved the wing chord response at the expense of the wing out-of-plane bending response. The peak wing bending is increased from 152 to 289 in-lbs, a factor of 1.9, and the peak chord response is reduced from 640 to 359 in-lbs, a factor of 1.8. Although difficult to observe in FIGS. 30A-30D, nacelle pitch is also reduced from 192 to 92 in-lbs, a factor of 1.8. Therefore, it is not clear which system results in better overall vibration reduction. However, it is apparent that AGPC successfully suppresses multiple modes whereas traditional GPC could only suppress the wing out-of-plane bending mode, even when the system ID is acquired at the same condition. Additionally, AGPC realizes a notable reduction in actuator workload over most of the time history.

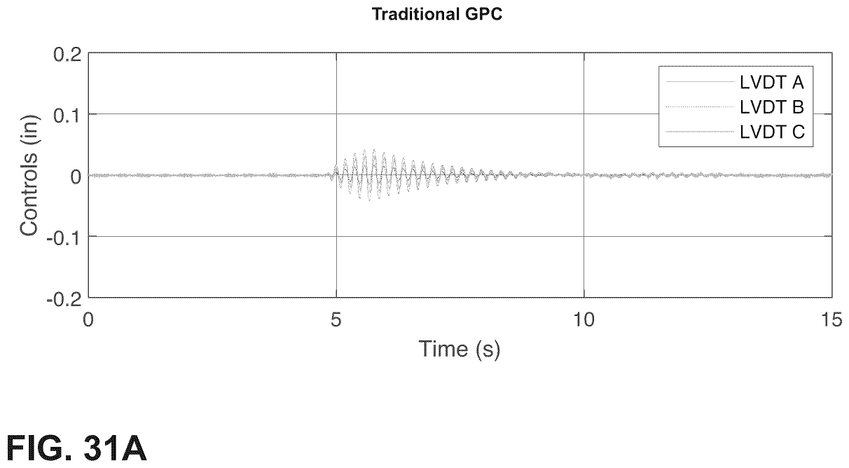

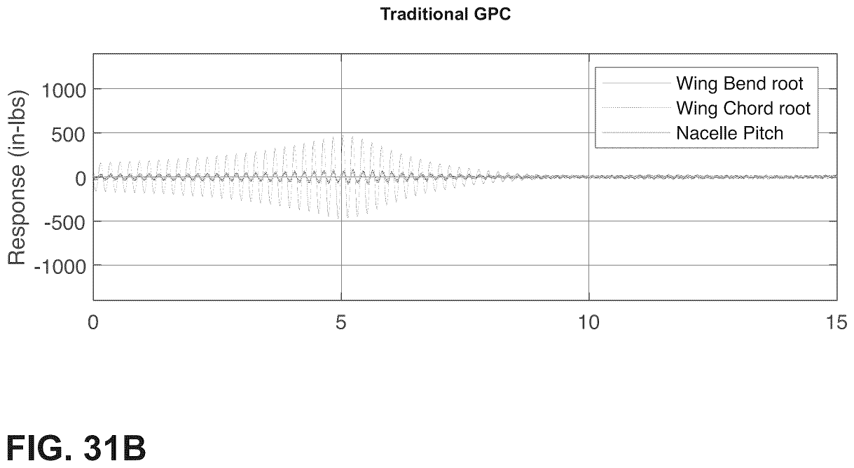

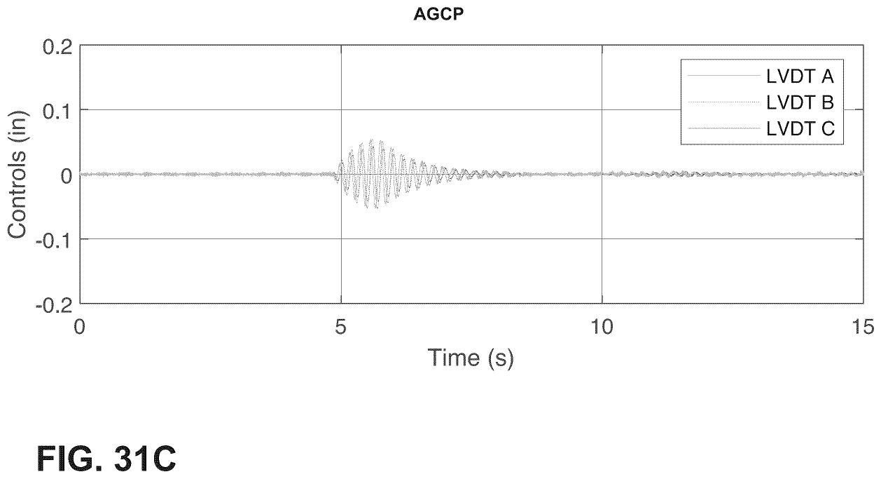

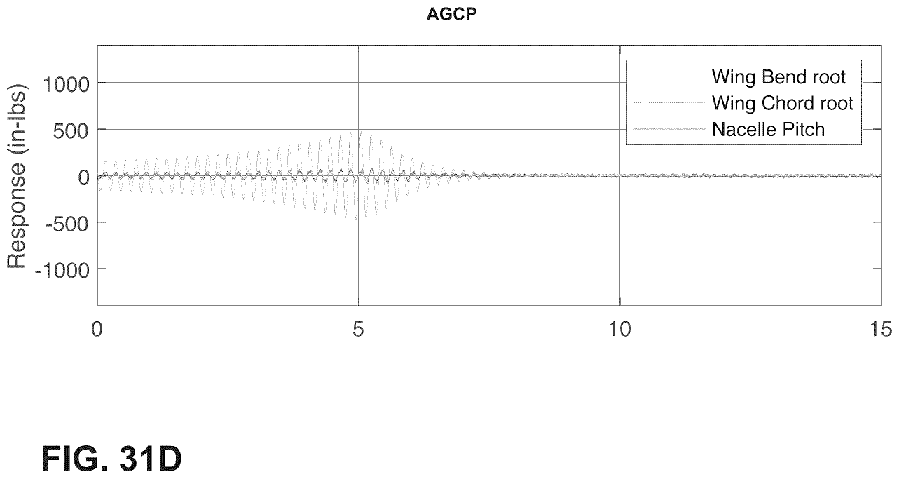

During testing, another comparison of traditional GPC and AGPC was conducted with the simulated dynamic instability. In this application, dither was added while the system was closed loop in order to improve the figures of merit. The resulting difference in performance is apparent by inspection of FIGS. 31A-31D which show a noticeable increase in system damping using AGPC.

The testing described herein demonstrates the ability of AGPC to perform better than traditional GPC at the same conditions where the system ID was acquired. AGPC according to the present disclosure also improves controller performance when the system is operating at conditions removed from one in which the system ID was acquired. Traditional GPC breaks down under such conditions as that demonstrated in testing with the simple tiltrotor model 20. Therefore, AGPC was also evaluated with the TRAST model 16 during rotor-on operation to evaluate the ability of AGPC to improve controller performance at resonant conditions.

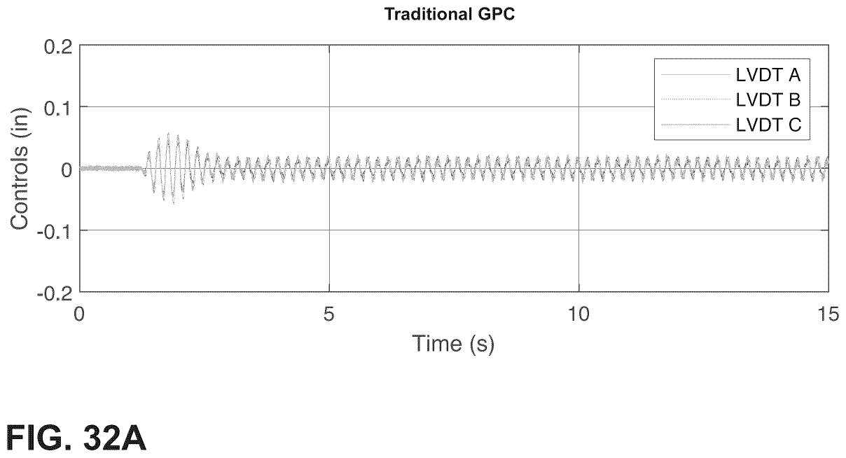

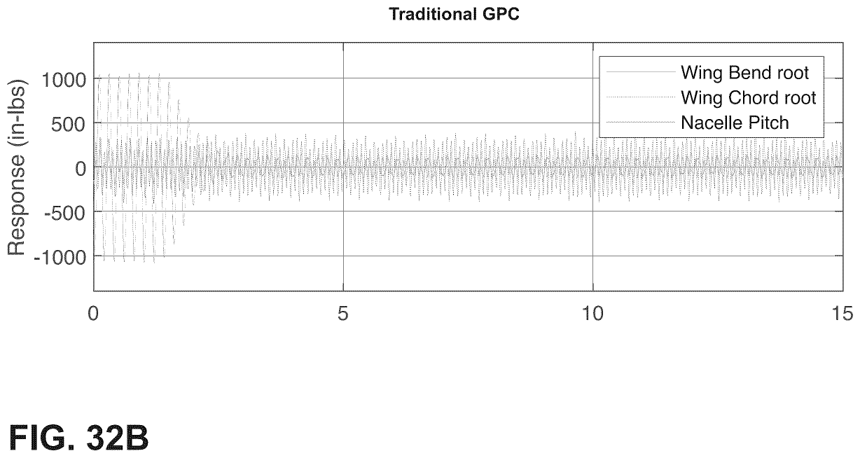

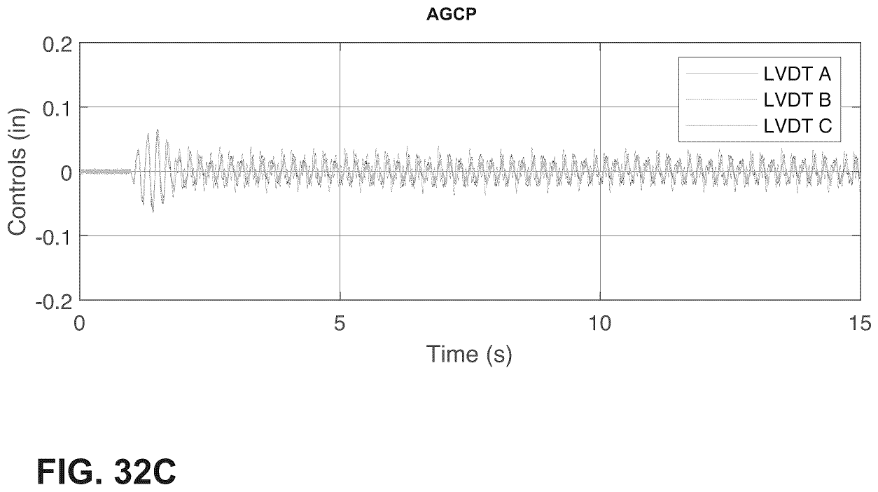

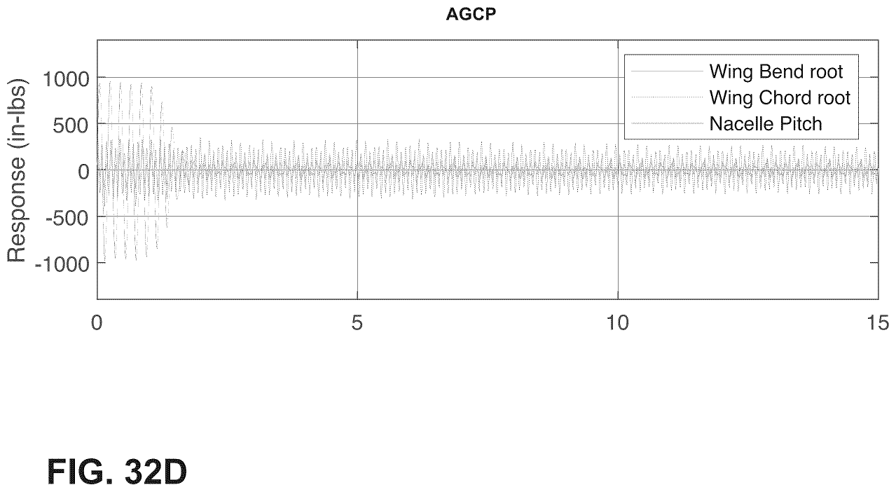

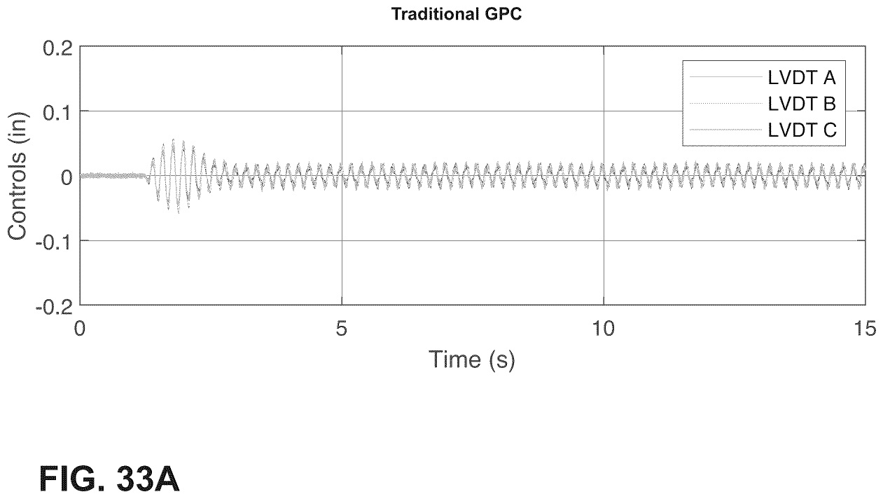

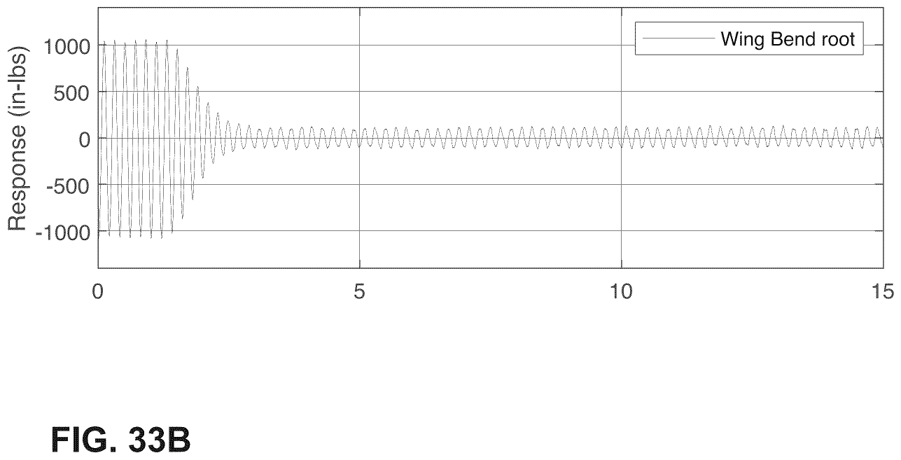

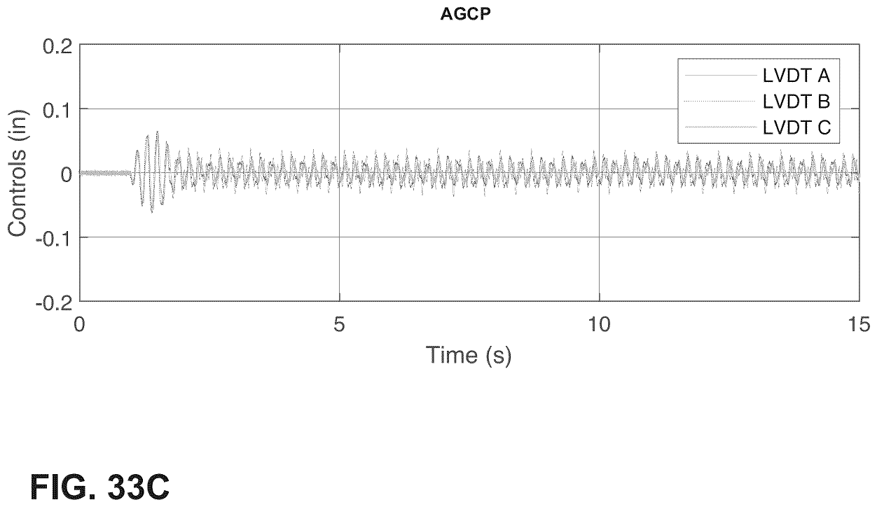

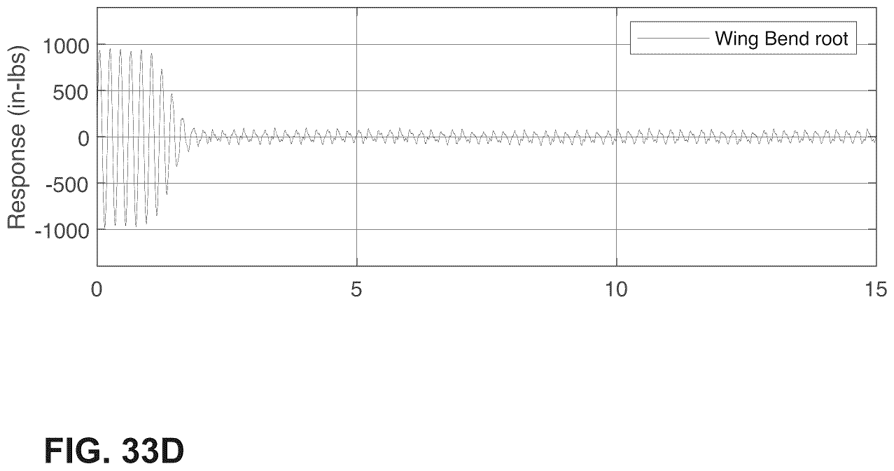

The resonant condition at 300 rpm offers an opportunity to test the adaptability of AGPC as intended since the acquisition of a system ID at this resonant condition using traditional methods is difficult due to the poor signal to noise ratios. Albeit traditional GPC control may still work well at 300 rpm with system ID data acquired at nearby conditions. The results of AGPC and a direct comparison to the performance of traditional GPC with the system ID acquired at 270 rpm is shown in FIGS. 32A-32D. As seen, AGPC is able to suppress the bending mode noticeably faster and also reduces the steady state vibrations of the wing chord and nacelle pitch modes by a slight amount. Since the resonant mode is the out-of-plane wing bending mode, one can see the steady state response better if the wing chord and nacelle pitch signals are removed. The same data record is shown in FIGS. 33A-33D with only the out-of-plane bending mode represented in the response traces. As seen during testing, AGPC outperformed traditional GPC at suppressing the wing bending mode at the resonant rpm.

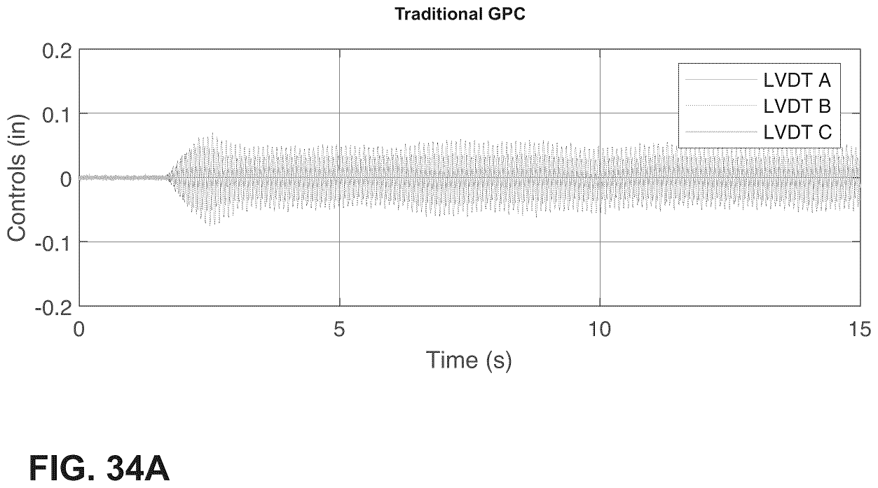

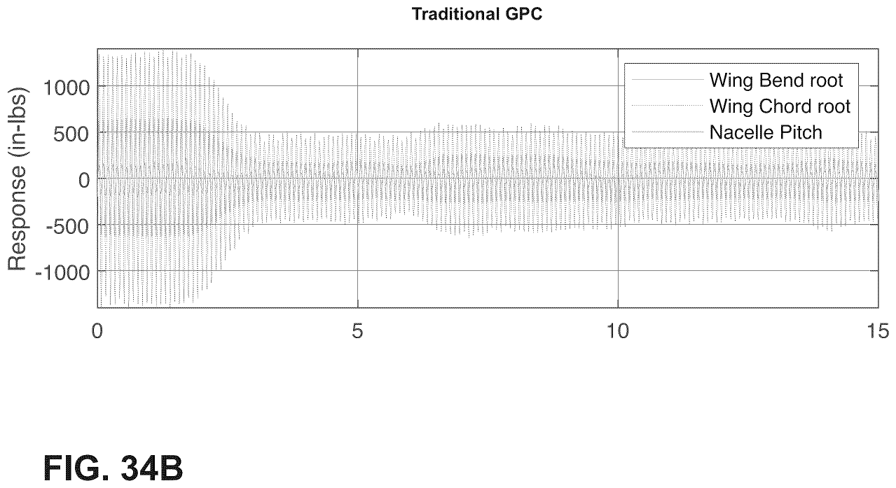

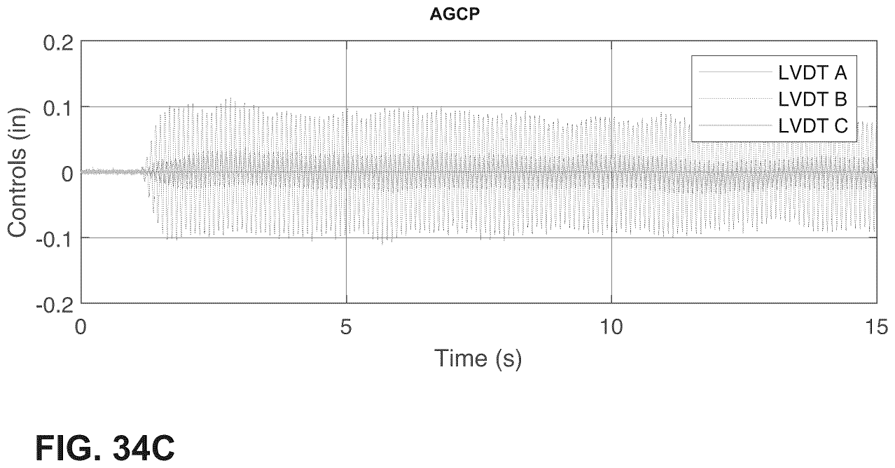

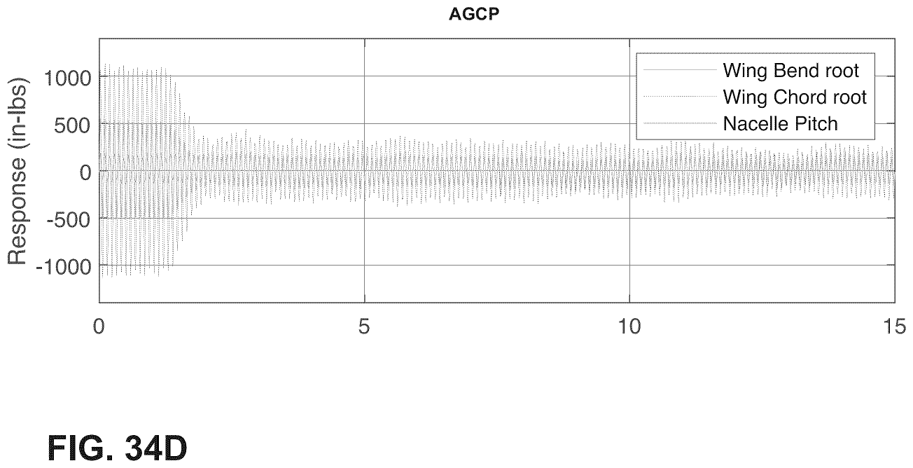

During testing, AGPC was also employed at the 680 rpm hover condition that excites wing chord in resonance. Similar to the wing out-of-plane bending mode, the TRAST model 16 can tolerate dwelling at 680 rpm, but the response is large and traditional GPC cannot acquire a system ID at this condition. An open-loop system ID was acquired at the nearby cruise rotor speed of 727 rpm. The response of the system at 680 rpm with traditional GPC using the system ID acquired at 727 rpm is shown in FIGS. 34A-34D. As shown, GPC is effective at reducing the resonant wing chord vibration and nacelle pitch.

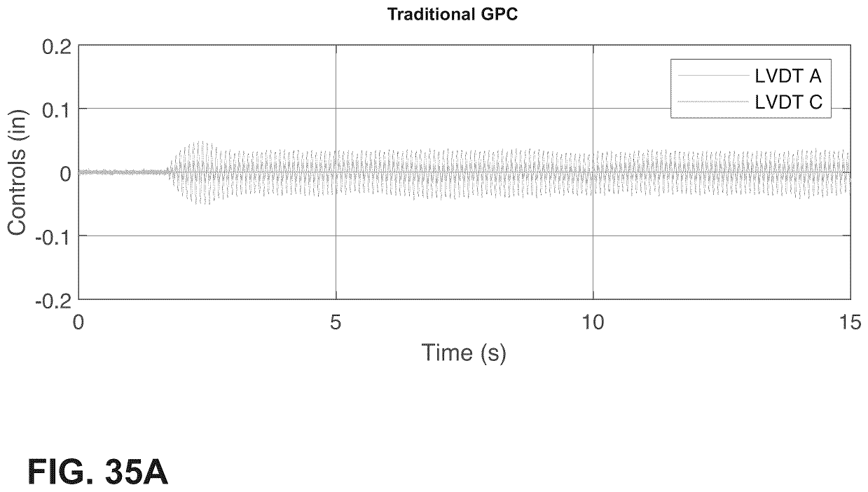

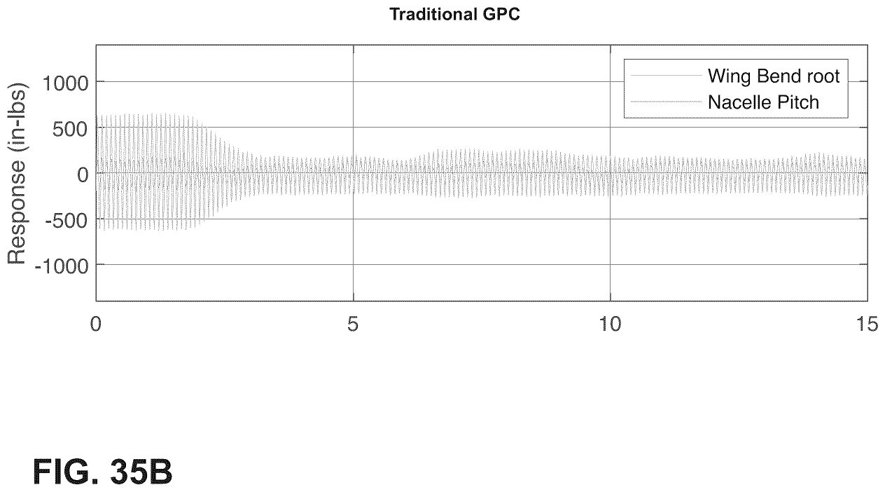

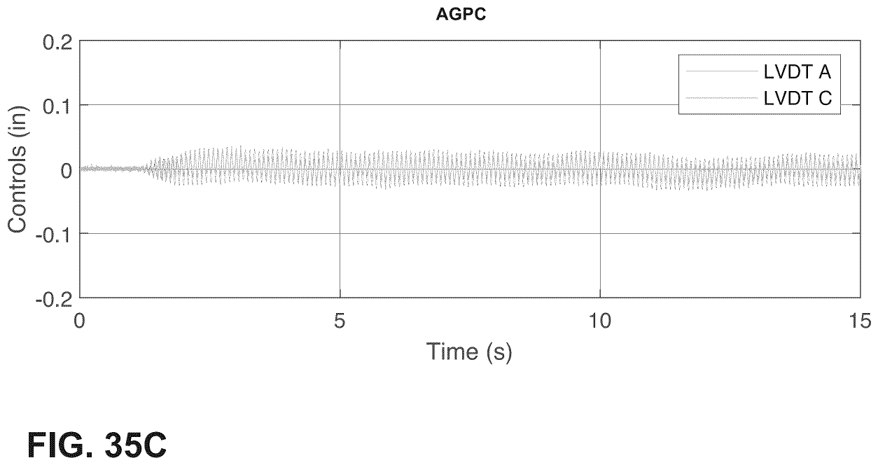

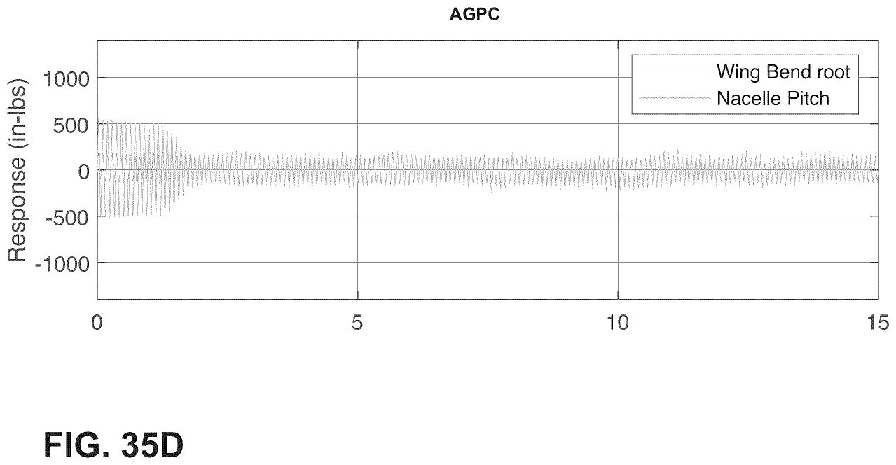

Similarly, during testing, AGPC was employed at 680 rpm and a comparison of the controller performance to traditional GPC using the system ID acquired at 727 rpm is shown in FIGS. 34A-34D. As observed, AGPC is more effective than traditional GPC at reducing the resonant wing chord vibration. FIGS. 35A-35D contain the same time histories with the wing chord and actuator B traces removed for clarity. In FIGS. 35A-35D, the ability of the controllers to suppress nacelle pitch and out-of-plane bending is more apparent. AGPC is also more capable of suppressing nacelle pitch than traditional GPC by a significant amount. However, the wing out-of-plane bending vibration is slightly increased with AGPC, but with comparable peak values to those observed with traditional GPC due to additional low-frequency content. Since this mode has by far the least amount of response at this condition, this slight increase is considered negligible compared to the overall vibration reduction of the system.

These experimental results with the TRAST model 16 demonstrate to the ability of AGPC to stabilize the TRAST model 16 farther beyond the flutter stability boundary than possible with traditional GPC efforts, similar to what was demonstrated with the simple tiltrotor model 20.

For all of the experimental results presented in the present disclosure, the same controller was used without any significant modification. Additionally, the same modeling parameters of sample rate, sample size, order of the model, and horizon sizes were used. This demonstrates the utility of GPC and AGPC, in that the same control law can stabilize multiple models as vastly different as the simple tiltrotor model 20 and the TRAST model 16 in multiple different configurations. The same controller is effective even with and without rotor blades installed by using experimental data to determine system behavior. This same controller and selection of modeling parameters was successful across these different models. This may be because the primary dynamics of interest were of similar frequency. Furthermore, if the measurement instrumentation is gained such that approximately the same voltage values correspond to maximum allowable responses and if approximately the same voltage command values correspond to maximum allowable excitation, then changes to the weighting matrices may not required for the controller to be functional across these different systems. However, adjustment of the weighting matrices may be utilized to optimize the controller for a particular model or configuration. Finally, with the same selection of modeling parameters, approximately the same figures of merit values indicate acceptable controller performance and system IDs for purposes of AGPC implementation.

Referring again to FIG. 1, a vehicle such as an aircraft 1 may include tiltrotors 2 and wings 3 that generally correspond to the TRAST model 16 described above. With further reference to FIG. 36, a control system 10 according to an aspect of the present disclosure may include a traditional GPC portion or control 12, and an advanced GPC control 14. The traditional GPC may be substantially similar to known GPC controllers, and may include a target response 64 (y_{T}), a buffer 66 (yₚ), and a buffer 68 (Uₚ) that are supplied to the controller model system 75. The buffer 70 and system ID process 72 provide the T, A, and B matrices. As shown by the arrows 78 and 80, the past response buffer 66 and past control inputs buffer 68 are utilized in the traditional GPC 12 and the advanced GPC 14.

At 82, the advanced GPC 14 utilizes the model of the system (T, A, and B matrices) and actual u (response) to predict future responses. The uproot of 82 is a predicted response y_{predict}, which is an input to a buffer 84 the response (y) of PLANT 77 is provided to buffer 66 of traditional GPC and to buffer 86 of advanced GPC. The predicted future responses from buffer 84 and the responses from PLANT 77 (buffer 86) are compared at 88 to provide the error between the target and measured response (ε). If the figures of merit 90 are adequate, the modeling parameters are adjusted at 99. As discussed below in connection with FIG. 37, if the figures of merit are not adequate, dither excitation may be added, and the controller may be observed to determine if the figures of merit are adequate after adding dither excitation. As shown by the arrow 94, the new T, A, and B (modeling parameters) are supplied to the controller model 75, and the new or present control inputs u of u_{c} are input at 76. As shown by the arrow 96, de min are also input to 76 if required.

With further reference to FIG. 37, a process 100 may be utilized to implement the control system 10. Process 100 includes determining a target response at 102, and acquiring a system id at 104. The controller is operated at 106, and the performance is evaluated at 108. If the performance is adequate at 108, the controller continues to operate as shown by the arrow 118. Thus, if the performance of a traditional GPC control 12 is adequate, it may not be necessary to utilize advanced GPC 14.

However, if the performance is determined to be inadequate at 108, a system ID is acquired as shown by the arrow 120, and the advanced GPC controller 14 observes the controller at 110. At 112, the AGPC control 14 determines if the figures of merit are adequate. If the figures of merit are not adequate, the AGPC 14 adds dither excitation at 16, and the controller is again observed at 110. If the figures of merit are determined to be adequate at 112, the modeling parameters are adjusted at 114, and the adjusted modeling parameters are utilized to operate the controller at 106 as shown by the arrow 124.

It will be understood that the control system of FIG. 36 and the process of FIG. 37 do not necessarily include distinct traditional GPC control 12 and distinct advanced GPC control 14. Rather, the designations of traditional and advanced GPC are provided to aid in understanding the control system 10 and process 100.

As discussed above, self-adaptive AGPC according to the present disclosure outperformed traditional GPC at conditions removed from those where the system ID was acquired. Also, unexpectedly, AGPC according to the present disclosure outperforms traditional GPC in some cases when used at the same conditions that the system ID was acquired. Furthermore, AGPC according to the present disclosure is capable of making adjustments with negligible impact to system response by contrast to traditional GPC that requires significant excitation of the system.

Adapting a poor performing control algorithm while not interfering with a good performing controller is an aspect of AGPC according to an aspect of the disclosure. Therefore, figures of merit were developed as described above to quantify the effectiveness of a working controller and to quantify the likelihood that individual input/output signals are distinguishable enough to properly characterize the system. When these figures of merit are satisfied, the self-adaptive AGPC of the present disclosure consistently improved controller performance and was shown to stabilize a dynamic system that traditional GPC could not stabilize.

### NOTATION

AGPC=advanced generalized predictive control
ARX=autoregressive moving average model with exogenous input
GPC=generalized predictive control
h_{c}=control horizon
hₚ=prediction horizon
k=time step index parameter
LVDT=linear variable displacement transducer
m=number of response measurements (outputs)
OMP=Observer Markov Parameters
p=order of the ARX equation, number of past inputs and responses in model
Q=weighting matrix for control (penalizes control)
r=number of control inputs
R=weighting matrix for error (penalizes error)
s=number of time steps used in system identification
TDT=Transonic Dynamics Tunnel, NASA Langley Research Center
TRAST=TiltRotor Aeroelastic Stability Testbed
u=control input
y=response output
ε=error between target and measured response (equal to the response for a regulator)
ξ=system modeling error between predicted and actual system response (error in OMP)

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method of controlling a vehicle utilizing a controller having a vehicle model that corresponds to the vehicle, the method comprising:
utilizing the controller to provide control inputs to vehicle actuators during vehicle operation;
determining modeling parameters of the vehicle model to model vehicle behavior, wherein the parameters are determined based upon utilized inputs and the measured outputs;
measuring vehicle outputs for a plurality of times while the vehicle is in operation;
determining predicted vehicle outputs for the plurality of times based, at least in part, on the determined modeling parameters;
determining a system error for the plurality of times utilizing a difference between the measuring vehicle outputs and the predicted vehicle outputs;
modifying the vehicle model of the controller to provide adaptive changes to the control inputs of vehicle actuators while the vehicle is in operation based, at least in part, on the system error.

2. The method of claim 1, including:
utilizing figures of merit to quantify the performance of the controller and a level of confidence associated with adaptive changes prior to providing the adaptive changes to the control inputs of vehicle actuators.

3. The method of claim 2, including:
utilizing figures of merit to determine a likelihood that the adaptive changes will improve performance of the controller.

4. The method of claim 3, wherein:
dither is added to the inputs if the figures of merit do not meet acceptable values; and
adjusting modeling parameters if the figures of merit meet acceptable values.

5. The method of claim 4, including:
observing the controller after adding dither;
followed by increasing the amount of dither if the figures of merit do not meet acceptable values.

6. The method of claim 1, wherein:
the vehicle model comprises T, A, and B observer matrices of an autoregressive model.

7. The method of claim 1, wherein:
the objective function is of the form:
J=ε^{T}Rε+uₕ_{_{c}}^{T}Quₕ_{_{c}};
wherein, ε is the error between the target response (y_{T}) and the predicted response ε=y_{T}−yₕ_{ₚ}, R is the weighting matrix for error, and Q is the weighting matrix for control input.

8. The method of claim 6, including:
determining a system error term in matrix form wherein:
$$ξ = {y}_{{h}_{{p}_{actual}}} - {y}_{{h}_{{p}_{predicted}}} + \{ φ \} = {y}_{{h}_{{p}_{actual}}} - [ {Tu}_{{h}_{{c}_{actual}}} ( k ) + {Ay}_{p} ( k - p ) + {Bu}_{p} ( k - p ) ] + \{ φ \} ;$$
determining updated values of T, A, and B, wherein the updated values are equal to the sum of the old values of T, A, and B and the changes in T, A, and B.

9. A vehicle control system comprising:
a controller having a vehicle model that corresponds to a vehicle, wherein the vehicle model comprises modeling parameters that are determined based upon utilized inputs and the measured outputs;
wherein the controller is configured to:
provide inputs to at least one vehicle actuator during vehicle operation;
measure vehicle outputs for a plurality of times while the vehicle is in operation;
determine predicted vehicle outputs for the plurality of times based, at least in part, on the determined modeling parameters;
determine a system error for the plurality of times utilizing a difference between the measuring vehicle outputs and the predicted vehicle outputs;
modify the vehicle model of the controller to provide adaptive changes to the inputs to the at least one vehicle actuator while the vehicle is in operation based, at least in part, on the system error.

10. The vehicle control system of claim 8, wherein:
the controller is configured to 1) utilize figures of merit to quantify the performance of the controller and a level of confidence of adaptive changes prior to providing adaptive changes, and 2) determine a likelihood that the adaptive changes will improve performance of the controller.

11. The vehicle control system of claim 10, wherein:
the controller is configured to 1) minimize an objective function, 2) add dither to the inputs if figures of merit are not acceptable values, and 3) adjust modeling parameters if the figures of merit are at acceptable values.

12. The vehicle control system of claim 11, wherein:
the controller is configured to observe the effects on vehicle output after adding dither followed by adding additional dither if the figures of merit are still below acceptable values.

13. The vehicle control system of claim 9, wherein:
the vehicle model comprises T, A, B observer matrices of an autoregressive model.

14. The vehicle control system of claim 9, wherein:
the objective function is of the form:
J=ε^{T}Rε+uₕ_{_{c}}^{T}Quₕ_{_{c}};
wherein, ε is the error between the target response (y_{T}) and the predicted response ε=y_{T}−yₕ_{ₚ}, R is the weighting matrix for error, and Q is the weighting matrix for control input.

15. The vehicle control system of claim 14, wherein:
the control is configured to determine a system error term in matrix form wherein:
$$ξ = {y}_{{h}_{{p}_{actual}}} - {y}_{{h}_{{p}_{predicted}}} + \{ φ \} = {y}_{{h}_{{p}_{actual}}} - [ {Tu}_{{h}_{{c}_{actual}}} ( k ) + {Ay}_{p} ( k - p ) + {Bu}_{p} ( k - p ) ] + \{ φ \} ;$$
the controller is configured to determine updated values of T, A, and B, wherein the updated values are equal to the sum of the old values of T, A, and B and the changes in T, A, and B.
